(19) United States
(12) Patent Application Publication
(10) Pub. No.: US 2003/0061132 A1
(43) Pub. Date: Mar. 27, 2003

(54) System and method for categorizing, aggregating and analyzing payment transactions data

(76) Inventors: Mason K. Yu, SR., Birmingham, MI (US); Mason K. Yu, JR., Walnut Creek, CA (US); Gregory J. Yu, Hillsborough, CA (US)

Correspondence Address: Global Law Group, Suite 311, 1601 Bayshore Hwy, Burlingame, CA, 94010, US

(21) Appl. No.: 09/965,100

(22) Filed: Sep. 26, 2001

(51) Int. Cl. G06F 17/60

(52) U.S. Cl. 705/30; 705/10

(57) ABSTRACT

Processed payment transaction records of consumer and business payers are received into a multi-dimensional networked data mart from databases originating from a multitude of financial institutions and payment processors. A post-processor linked to the data mart assigns all such transaction records with universal consumer and business expenditure categories used for payer financial management. Post-processed payment transaction records are indexed in the data mart by time, geography, and the universal consumer and business expenditure categories. Mathematical and analytical tools are applied to aggregated payment transaction records according to geographic, topographical, meteorological, chronological, demographic and other parameters. Endusers interact electronically with the data mart to view, create, synthesize and receive post-processed payment data for economic, investment, business, and marketing analysis.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

The present invention relates to categorizing, aggregating and analyzing consumer and business payment transactions data according to geographic, demographic, topological, meteorological, and chronological and other parameters for analysis by endusers.

2. Description of Prior Art

Today there is a persistent need for more timely and accurate reporting, understanding and analysis of economic events. Economic events only occur when a medium of exchange is made among consumers, businesses and government. The primary method of exchange is monetary payment. Consumer spending stands as the linchpin of a market economy. Therefore, economic indices, projections and forecasting revolve around the questions of how, why, and when are payments made in a macroeconomic system. Any economic measure requires the categorization of spending of single economic units. Three existing methods are available. First, survey data on consumption is retrieved from actual consumers and small businesses. Second, proprietary and non-proprietary personal financial management tools and devices categorize expenditures of consumers and businesses. Third, document and data management technology captures, creates and classifies payment documents and data of consumers and businesses.

### Survey Data on Spending

Personal consumption data collected by the U.S., state and local governments forms the foundation for fundamental government, tax and fiscal policy. Current economic measures of consumer expenditures for the U. S. economy are crucial to a reliable estimate of the Gross Domestic Product (GDP). During nonwar years, personal consumption dollars account for anywhere from 65 to 80 percent of total GDP. The basic components of personal consumption are durable goods, nondurable goods, and services. With trends and projections of demand, government and business can produce adequate sources of goods and services for future periods. Any nominal gain in accuracy of projections will significantly alter fiscal and tax consequences for the U.S. economy. For example, the Congressional Budget Office (CBO) estimates that a slight 0.1% variance in measuring growth means a swing of $244 billion in projected surpluses or deficits over a 10-year period.

Likewise, business spending data form the foundation for a multitude of leading and lagging economic indicators. Business payments data are the raw material for Producer Price Index, nonresidential fixed investment and related measures. Without timely, accurate business spending data, derivative indices become suspect and business planning is misdirected.

The validity of CBO projections of GDP depends heavily on analysis supplied by the Bureau of Economic Analysis (BEA), a statistical agency within the U.S. Commerce Department's Economic and Statistics Administration. BEA statistics are used by the CBO for estimating economic growth for Federal budget projections, by Federal and state agencies for administering aid and grants on a regional basis, and by private sector firms for business forecasts, production and investment plans. BEA itself does not gather consumption data. Instead, it extracts data from surveys and censuses of the Census Bureau, from the Bureau of Labor Statistics (BLS), from tabulations of the IRS, and from various private sources.

Currently, there are inherent flaws in spending data and statistics. The GDP today assumes that spending is a constant, proportionate percentage of income. This is a fundamental principle in the 1936 treatise of Lord Keynes, the founder of modern economic thought, and his ideas still have tremendous following. As Keynes postulates, consumer expenditures will always fall in the range of 0 to 100% of household income. This is nothing more than an inventory of assets that will be completely unsold, partially sold, or completely sold. Aside from the absolute difficulty of predicting consumer spending behavior, Keynes did not and could not account for the credit card. Credit cards allow a household to easily outspend income.

Until 1981, BLS relied on developing a composite list of hundreds of item choices to formulate family budget levels for the U.S. A special advisory committee then found that expenditure categories were a far more reliable approach. At that point, BLS began its own surveys to measure expenditure allocation (CEX, as discussed below). Nonetheless, family budgets are important factors to formulate cost-of-living indices and poverty levels.

Consumer expenditure measures and indices rarely tap actual transactional data of households and businesses. Inaccurate consumption data impedes proper economic planning. If consumption growth is not detected early enough, the perception of an economic recession lingers. Overreaction or delayed responses by the Federal Reserve, the Treasury or banks actually exacerbate unfavorable conditions in the economy. A delayed reaction by business can cause inflation arising from insufficient supplies to meet demand.

Other industrialized nations make consumption data capture crucial to economic analysis. In Japan, household spending is a key element of estimates of “Gross National Expenditures” and the “Consumer Price Index”. Households randomly selected throughout the country are asked to complete a survey and record “Family Account Books” for a six-month period. These include standardized breakdowns into the following 10 categories: Food, Housing, Fuel, light & water, Furniture and household utensils, Clothes and footwear, Medical care, Transportation and communication, Education, Reading and recreation, and Other. Without diligence in recording spending data, such data and resulting figures are flawed. Even a six-month, government-mandated record cannot necessarily account for biases, infrequent durable goods purchases, or the lack of incentives to remain faithful and accurate in written responses.

In the U.S. the standard decennial Census questionnaire asks for household income but is silent on categories of expenditures for the household. Personal Consumption Expenditures (PCE) represents a major component of the Gross Domestic Product. Those key components are: Motor vehicles, Furniture, Other durables, Food, Clothing, Energy goods, Other nondurables, Housing, Household operation, Transportation, Medical care, Recreation and Other services. The other leading government source for consumer spending data is the Consumer Expenditure Survey (CEX). PCE has some key inclusions omitted by CEX. For example, PCE includes private and public sector employees working abroad, and CEX does not. PCE manages to impute a number of items not actually paid for by the household, such as housing and financial services, rent, and meals provided by the government and the employer. CEX, as a measure, factors in only out-of-pocket spending.

In spite of its limitations, CEX as generated by the Bureau of Economic Analysis (BEA) of the U.S. Department of Commerce, is the standard bearer of economic measuring tools. The Consumer Price Index (CPI) is based in part on the CEX. CPI is the aggregate, representative index of price change as experienced by households. Unit prices of household items are only one component of CPI. CPI also incorporates actual spending behavior of households. Since CPI calculations require a spread among various household groups by total amounts consumed, statistical analyses require overall dollar volume of each relevant spending category. As various household groups are analyzed and averaged, the CPI attempts to be representative. CPI estimates still draw heavily on responses in surveys conducted through the CEX. Point-of-Purchase surveys are utilized, but they are still based on mechanical answers rather than traced to actual transactions.

The CEX has two components for construction of data—the Diary Survey and the Interview Survey. The Diary asks the participant to record his or her expenditures for one week on a manual paper basis). The first week's Diary is followed by a second and final Diary for an additional week. The Interview Survey involves a visit once every three months for five consecutive quarters. CEX surveys are unreliable. First, there is no independent obligation to participate or to be truthful and accurate, other than civic duty. This duty may be weaker than other industrialized nations that measure GDP. Second, where no written record of spending exists, human memory must fill in the missing gaps. The CEX survey records are in no way audited against tax, business or banking records. Statistical extrapolations from unaudited recollections of spending make the resulting indices suspect.

Voluntary participation in using humanly recalled data is no match for actual, timely transactional data recorded by automated computer systems with negligible human intervention. For example, scanning devices at point of sale for retail goods now monitor consumer spending and prices for the CPI. The scanner data allows more complete weighting of the universe of goods measured. Dynamically captured and recorded data is extremely valuable for calculation of projections and indices. Even so, such computer-generated transactional data misses the mark for economic measures because there is no capture of spending over a time interval for a particular type of good.

Data gathering on consumption is further handicapped by severe time lags. As with most economic indices, lag time extends from the actual event to the reporting point. Further, key consumption measures are highly seasonal as the case with consumer retail purchases. It is commonly known that 50% of consumer purchases of goods falls during the holiday season toward the end of each calendar year.

Measuring consumer spending today does not cover services. For durable and nondurable goods, businesses regularly report revenues from the sale of goods. Much of the service industry relates to providers who could be private individuals who perform manual labor or who rent living quarters to a household. For example, rent for owner-occupied housing is an imputed FIG. within the GDP measure. Services are often estimates with sporadic data.

Further, there is a scarcity of data on savings and savings rates for U.S. households. Savings in theory is basically deferred consumption. Independent measures are completely absent because they are nearly impossible to measure on a broad scale. Therefore, savings is no more than a residual calculation, that is, the excess of personal income over personal outlays. Currently, there are no sources for even estimating savings. The personal saving ratio is the quotient of personal savings over personal disposable income. Disposable income itself requires reliable categorization on a broad public basis. That system does not exist. With such indeterminate and unreliable components, the personal savings rates are too volatile to rely on.

The United States from 1980 to 1995 had a personal savings rate that was not even in the top 10 countries of industrialized nations. During this period, the rate fell from 8.4% to 4.7% of discretionary income. If a tool delivered more accurate and timely information on savings rates, government and private households could plan and react sooner.

### Personal Tools for Tracking Spending

Expenditure tracking for households and businesses is achieved through a variety of patented and non-patented personal financial management (PFM) tools. PFM tools operate on PCs, various card products, and checking accounts. Most attention and investment is devoted to electronic online banking due to the cost savings to financial institutions. Any aggregation of such categorized data, however, is skewed heavily toward educated, higher income segments of the economy. As such, most retail banking markets cannot attract more than 10% of the base to consistently use online banking. Only a fraction of that group is actually engaged in daily expenditure tracking unless they invest time in manual data entry at home.

Online access devices such as credit cards and debit cards authorize payment with an embossed account number on one side and a magnetic stripe containing account information in machine-readable form on the other side. Debit cards deduct funds directly from the enduser's bank account using an automated teller machine (ATM) or point of sale (POS) terminal. With either type of card, the merchant handling the transaction has a relationship with the bank and card association. Credit card associations have traditionally offered expenditure classification for cardholders. The production of such card data relies solely on the merchant's identity, i.e., its standard industry classification (SIC). The

demand deposit account comes closest to a ubiquitous tool for household and business financial management. According to a survey in 1998, 91.5% of all households had some type of transaction account, including checking accounts. Among small businesses, 94% had a checking account. These percentages are far greater than any other payment device, including debit and credit cards. Aside from currency, the check is the most portable and negotiable instrument of payment. While the debit card works like a credit card, the source of the funds for a debit card is still the checking account. Nearly every business requires checks in order to maintain a record of payments for tax purposes. The household checking account is most frequently used for larger, tax-deductible purchases. In other words, the most comprehensive view of the financial cash flow of a typical household flows out of the checking account. Both the PCE and the CEX measures focus on purchases of new goods from retailers and service providers. The checking account includes payments for services and used goods from private parties and unincorporated organizations. While business tax returns mush break down in detail the categories for overall deductible items, the consumer has no such requirement, except when itemizing only selected items. Hence, outside of its data on itemized deductions, the IRS cannot provide any such consumer expenditure data useful for economic analysis and forecasting.

Patented tools for expense tracking are restricted to individual account analysis. The Yu patent issued in 1995 (U.S. Pat. No. 5,433,483) and the Kunkler patents (U.S. Pat. Nos. 5,740,271, 5,917,931, and 6,014,454) each propose categories for expenditure tracking off the paper check. However, none of these patents claim the aggregation of such data among multiple customers into standardized categories for econometric and demographic analyses. U.S. Pat. No. 5,630,073 issued to Nolan in 1997 uses checks and deposit slips for tracking spending, assets and liabilities of individuals and small businesses. The prescribed system does not address the need and problem of calculating and aggregating groups of customers for economic analysis of consumption.

Other solutions for expenditure tracking off the paper check are nonproprietary. Each of them uses a pre-set list of expense categories and allows the check writer to add additional customized categories. These solutions do not aggregate spending data among multiple customers. Aggregation is not done and neither is it done among a standard list of categories, either for household or business analysis. The emphasis is on customization of categories, not standardization that would facilitate aggregation of categories. Generally, any level of customization makes it nearly impossible to make useful aggregations of data.

Credit cards provide classification of charges on a quarterly and annual basis for individual and corporate cardholders. The charges, however, are not grouped into standard categories among multiple individual and corporate holders for economic analysis. Another Yu patent, issued in 1998 (U.S. Pat. No. 5,748,908), tracks expenditures made with credit cards and debit cards, but does not contemplate aggregating such data among customers into common categories.

A solution that has been implemented on a limited basis is smart card technology. Vendors imbed an electronic memory chip into a plastic card that holds and dispenses currency values. The chip is a repository of extensive demographic, customer and transactional data. U.S. Pat. No. 5,559,313 issued to Claus, et al. in 1996 describes the use of the card to track items purchased and organized in tabular format for budgeting purposes. This patent claims the extraction of such table to a personal computer, but does not contemplate the aggregation of data among multiple customers into a separate database.

A more comprehensive means of categorizing payments requires the use of a personal computer and personal financial management software. U.S. Pat. No. 5,920,848 issued to Schutzer, et al. in 1999 provides for the linkage of payment expense data between a specific enduser and the client server. All contemplated analysis focuses on user-specific needs and not aggregated user data for further historical and trend analysis on a macroeconomic basis. As much as PC tools can be accurate, individual consumers and businesses lack an incentive to upload that data on a regular basis to a central reporting agency (except to the IRS) or to the financial institution that maintains a transaction account for the customer.

Individual economic units cannot accurately track their spending without PC use or extraordinary manual effort to sort and aggregate transactions with cash, checks, credit cards, debit cards, smart cards and electronic devices. Even if individualized payment management is satisfactory and reliable, no efficient channel exists to collect data that resides on home PCs and laptop computers. Aggregating spending data is impossible when consumers and business use numerous types of measuring tools. Various charts of accounts and templates, especially when customized, lack uniformity. Therefore, collecting such data on a case-by-case basis is unwieldy and unworthy for any sensible accumulation and analysis. Government agencies, such as the Census Bureau or the IRS, cannot mandate even greater reporting burdens on individuals and private businesses to provide data from their PFM tools.

### Document and Data Management Technology

Document and data management technology is pervasive. Existing categorization tools for documents are too generalized to effectively manage payment data, even when reduced to a physical format. Specific means to monitor spending behavior aim to increase sales of specific customers of specific businesses. The source of customer data available for capture is confined to purchases of goods and services from the specific vendor or business seeking to increase sales. These systems and means do not attempt a uniform categorization or indexing system that collectively applies to multiple vendors and businesses.

U.S. Pat. No. 5,832,470 issued to Morita et al. in 1998 classifies documents using sets of key words and a thesaurus. The classification system requires a generalized search in each document for words, as opposed to a data field inside a payment transaction record. Nor is the system designed to provide identical indices for multiple organizations and businesses.

U.S. Pat. No. 6,185,576 issued to McIntosh in 2001 creates a universal document classification system for an enterprise for administrative purposes such as record retention. The system does not extract and interpret content from documents for release to outside parties for marketing, financial or economic use.

U.S. Pat. No. 6,119,933 issued to Wong et al. in 2000 provides a means to capture and store customer transactional data in a database to create a loyalty and rewards program. The database aims to analyze and predict behavior of a customer based on past transactional history. However, such data is not used to provide a comprehensive spending profile of customers with the use of expenditure categories for customer financial management.

A related patent, U.S. Pat. No. 6,009,415 issued to Shurling et al. in 1999, also rewards customers based on prior purchase behavior, this time in the case of banks. Detailed analyses are performed on each specific customer and a comparison is made to other customers. It does not attempt to aggregate transactional histories for group analysis.

Under U.S. Pat. No. 6,039,244 issued to Finsterwold in 2000, a database is built to collect purchase data of a customer to increase sales for the customer. The data is analyzed on an individual customer basis only.

U.S. Pat. No. 5,930,764 issued to Melchione, et al. in 1999 collects all contacts with a bank customer to develop a tailored marketing analysis and campaign. The collection of the data relates only to the interaction and transactions between the customer and the bank. It does not address how transactional behavior with payments to third parties can be analyzed and presented for demographic and economic analysis. When public demographic information is aligned with customer data here, no aggregation or economic analysis arises.

Overall, data gathering sources and tools in both the public and private sectors lack any means to categorize and aggregate purchasing data from payment transactions.

### SUMMARY OF THE INVENTION

It is an object of the present invention to aggregate within an electronic data warehouse payments data under universal spending categories and make the warehouse indexible by spending category.

It is another object of the present invention to aggregate payment data inside the warehouse by multiple parameters such as geographic base of individual consumers and businesses, time periods, and demographic classifications,

It is still another object to aid and enhance the capture of consumer and business spending for economic analysis performed by various government agencies. Most economic indices are based on survey data. The present invention overcomes the deficiencies of surveys with real-time capture of payment transaction data. This time-sensitive tool yields actual consumption dollars in various categories on a mass basis. Also, more accurate weights are assigned based on actual spending of an entire household among universal categories to be measured for CPI analysis. The fixed market basket under the present invention can be dynamically and geographically adjusted based on actual payment data in real dollars.

Another object of the invention is to aggregate and analyze payment data in categories that are common to both consumers and businesses for greater market and economic analysis.

A further object is to designate a specific expenditure category to track investments and savings of consumers and businesses. There is a voluntary outflow of income into a savings or investment account owned by the household or the business. The invention is the first-ever, independent capture tool for aggregated household savings data.

In addition, the present invention provides reports of consumption by universal categories that are aligned to those used by government agencies. The data warehouse as created by the present invention delivers electronically general, standard, frequently requested reports as well as i,specialized reports and analyses based on heuristic queries. The present invention is designed to automatically depersonalize specific payment transaction data to prevent potential infringement of privacy.

### DRAWINGS

In the drawings, closely related FIGS. have the same number but different alphabetic suffixes.

FIG. 1A displays various dimensions of National Economic Data Warehouse (NEDW) as a data hypercube.

FIG. 1B is an isometric view of the three-dimensional graph of the consumer cube of NEDW.

FIG. 1C is an isometric view of the three-dimensional graph of the business cube of NEDW.

FIG. 2 lays out the overall systems network architecture of NEDW.

FIG. 3 illustrates the flow of data from payment processors through a post-processing filter.

FIG. 4 demonstrates the detailed functional processing of sample consumer payments and business payments data arising from FIG. 3.

FIG. 5A is a diagram of a system to process paper checks toward generating expenditure classification data.

FIG. 5B is a diagram of the specific processing steps of the system in FIG. 5A.

FIG. 6 is a diagram of the processing of non-paper check payments toward generating expenditure classification data.

FIG. 7A shows the two dimensions of expenditure category and time for consumer payments.

FIG. 7B shows the two dimensions of expenditure category and time for business payments.

FIG. 7C illustrates the assembly of a weekly time column vector for consumer payments.

FIG. 7D illustrates the assembly of a monthly time column vector for consumer payments.

FIG. 7E illustrates the assembly of a yearly time column vector for consumer payments.

FIG. 8A illustrates the assembly of a weekly expenditure row vector for specific consumer payment categories.

FIG. 8B illustrates the assembly of a monthly expenditure row vector for specific consumer payment categories.

FIG. 8C illustrates the assembly of a yearly expenditure row vector for specific consumer payment categories.

FIG. 9A illustrates the assembly of a weekly time column vector for business payments.

FIG. 9B illustrates the assembly of a monthly time column vector for business payments.

FIG. 9C illustrates the assembly of a yearly time column vector for business payments.

FIG. 10A illustrates the assembly of a weekly expenditure row vector for specific business payment categories.

FIG. 10B illustrates the assembly of a monthly expenditure row vector for specific business payment categories.

FIG. 10C illustrates the assembly of a yearly expenditure row vector for specific business payment categories.

FIG. 11A demonstrates the creation of macro time slices of consumer payments and of macro expenditure layers of consumer payments.

FIG. 11B demonstrates the creation of macro time slices of business payments and of macro expenditure layers of business payments.

FIG. 11C demonstrates the construction of micro customer statement matrices and the aggregation of multiple customer statement matrices.

FIG. 12 shows the operation of an OLAP engine to extract categorized consumer payments by use of a consumer customer profile vector.

FIG. 13 shows the operation of an OLAP engine with predictive analytics to input an additional database vector to further analyze categorized consumer payments.

FIG. 14 shows the operation of an OLAP engine to extract categorized time column vectors of consumer payments by use of a consumer customer profile vector.

FIG. 15 shows the operation of an OLAP engine with predictive analytics to input an additional database vector to further analyze categorized time column vectors.

FIG. 16 shows the operation of an OLAP engine to extract categorized business payments by use of a business customer profile vector.

FIG. 17 shows the operation of an OLAP engine with predictive analytics to input additional databases to further analyze categorized business payments.

FIG. 18 shows the operation of an OLAP engine to extract categorized time column vectors of business consumer payments by use of a business customer profile vector.

FIG. 19 shows the operation of an OLAP engine with predictive analytics to input additional databases to further analyze categorized time column vectors.

FIG. 20 shows the operation of an OLAP engine with predictive analytics to input multiple database vectors to generate complex predictions of projected payments and indices.

FIG. 21 shows the systems network for delivery and access of NEDW data.

FIG. 22 shows the systems architecture for an REDW Intranet.

FIG. 23 shows an NEDW e-Portal computer screen at log-in.

FIG. 24 shows an NEDW e-Portal computer screen for initiating OLAP queries.

FIG. 25 shows a computer screen for input of consumer profile vectors and time vectors.

FIG. 26A shows a computer screen for input of specific universal consumer categories for OLAP analysis.

FIG. 26B shows a computer screen for input of specific universal business categories for OLAP analysis.

FIG. 27 shows a computer screen for input of business profile vectors and time vectors.

FIG. 28 shows a computer screen for making OLAP requests against the business cube of NEDW.

FIG. 29 demonstrates the combination of consumer and business expenditure NEDW layers by common universal expenditure categories.

FIG. 30 depicts alternative means of electronic delivery of NEDW data and reports.

### DETAILED DESCRIPTION OF THE INVENTION

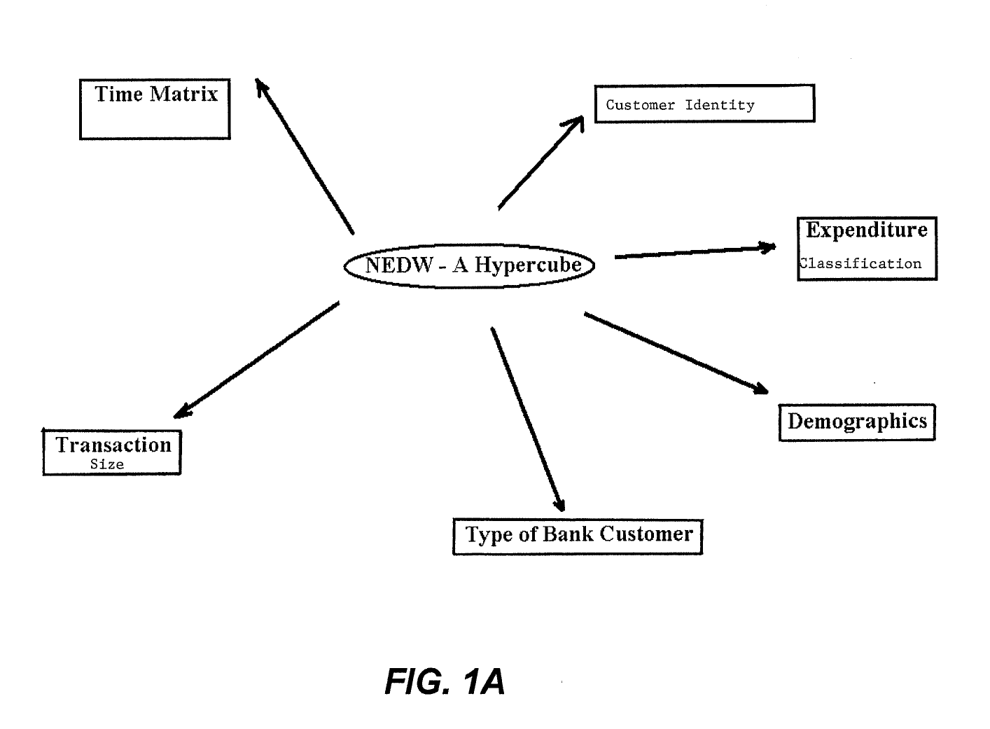

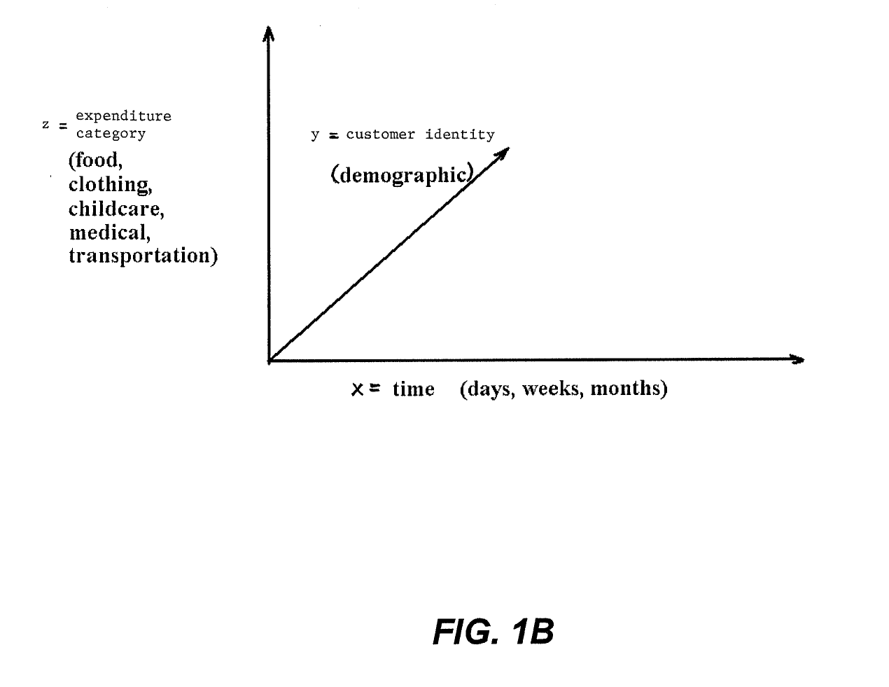

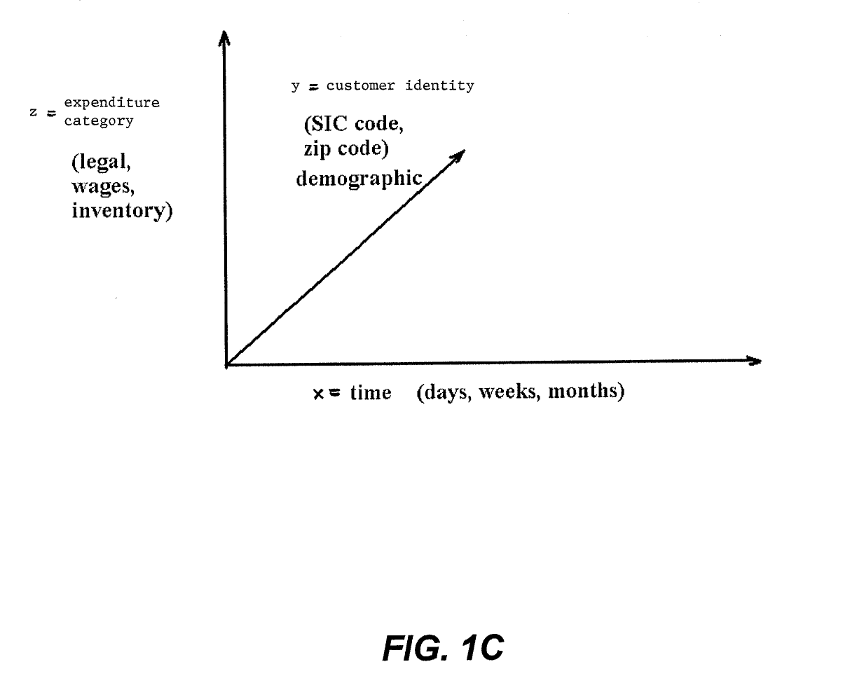

FIG. 1A describes the conceptual utility of the invention. The invention accumulates, processes and organizes payments data according to a new dimension called expenditure classification. The data is stored inside a distributed data warehouse system, National Economic Data Warehouse (NEDW). NEDW is an n-dimensional hypercube data warehouse system. In FIG. 1A, the radiating black lines represent various dimensions. In the upper half of FIG. 1A, the preferred embodiment utilizes three basic dimensions—time, customer identity, and expenditure classification. The standard dimension of time is applied for internal accounting of payment processing. Customer identity allows a payment processor to generate and deliver individual customer data and statements. When customer identity is ignored, NEDW aggregates payments data. Expenditure categorization introduces a universal surge in the accessibility and use of payments data. In the lower half FIG. 1A, other possible dimensions for conceptualization and analysis include demographics, type of bank customer, and transaction size. As dimensions are added to NEDW, more systems design and programming becomes deliverable by systems architects, database/network designers and CTO/CIOs responsible for construction of NEDW.

The preferred embodiment creates consumer payments and business payments as the two primary cubes of NEDW. In FIG. 1B, the consumer cube of NEDW shows the x axis as customer identity and demographics, and they axis as time, The invention introduces the vertical z axis as sample consumer expenditure categories such as food, clothing, etc. Without the present invention, data warehouses for payments only track time and unique and generic customer identity (demographics). A suggested set of universal consumer expenditure categories is the following:

Childcare—expenses to care of minors and dependents, alimony

Clothing—garments, footwear, jewelry, cleaning and repairs

Credit card—payments of principal and interest on consumer credit

Donations—voluntary contributions to organizations

Education—tuition, books, fees, equipment

Food—food and beverages purchased for consumption at home

Housing—mortgages, rents, services, furnishings, textiles, floor, appliances

Investment—transfers to savings, investment, retirement accounts

Medical—actual out-of-pocket costs to providers, pharmacies and insurers

Recreation—vacation, sporting events, movies, toys, pets

Taxes—income taxes, property taxes

Transportation—purchases, maintenance, commuting, mass transit, licenses

Utilities, divided by:

Electric

Heat

Telephone—includes voice, fax, and Internet

Water

Miscellaneous—other expenditures

Three major axes for the business cube of NEDW appear in FIG. 1C. The verticaly axis represents the business expenditure category, such as wages, legal and purchases. A suggested set of universal business expenditure categories is the following:

Advertising—promotional costs, brand development

Credit card—payments of principal and interest on business credit

Health—insurance claims and premiums for self and staff coverage

Insurance—property and casualty coverage claims and premiums

IRA-401K—any means for retirement benefits

Legal—professional fees and costs for legal services

Purchase—acquisition costs for fixed assets and/or inventory

Rent—office and equipment rent and leases

Taxes—property, use, sales and income taxes

Transportation—purchases, car leases and maintenance, licenses

Utilities, divided by:

Electric

Heat

Telephone—includes voice, fax, and Internet

Water

Wages—staff wages, salaries, payroll taxes and benefits

Miscellaneous—other expenditures

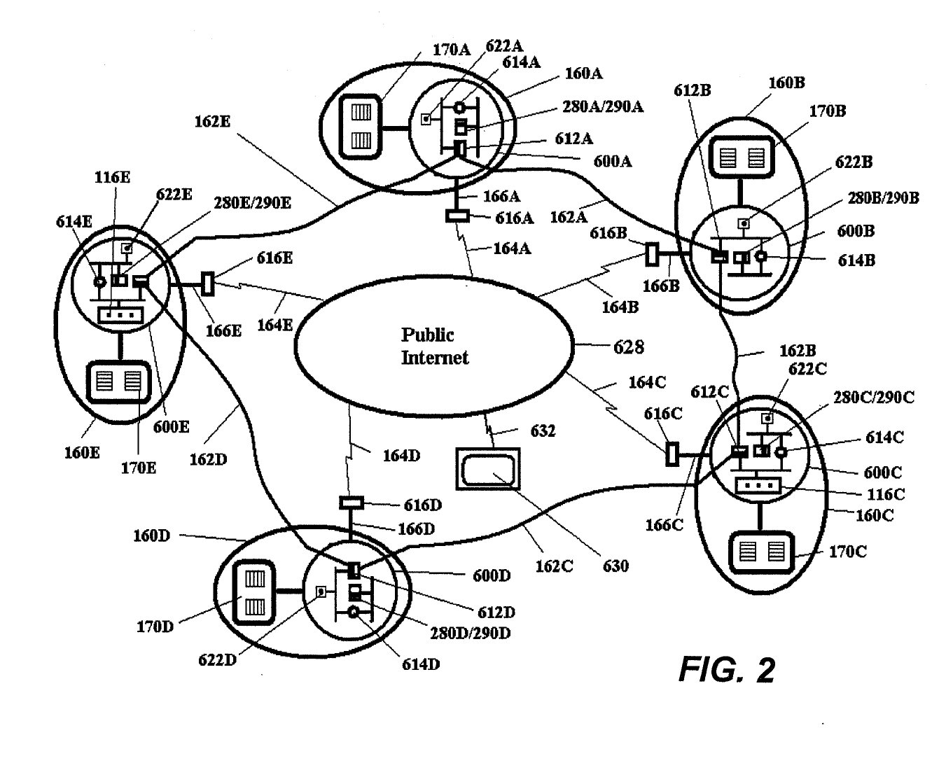

FIG. 2—Network Architecture of the System

FIG. 2 presents the overall computer architecture for NEDW. The foundation of NEDW is a distributed database system with two components—a composite very large database (VLDB) and a very large storage area network (VLSAN). FIG. 2 shows NEDW comprised of five Regional Economic Data Warehouse Systems (REDWs) 160A, 160B, 160C, 160D, and 160E, each represented by an oval on the perimeter of NEDW. (Note: In FIG. 2, components having the same number and different alphabetic suffix have identical functionality but are located in different REDW 600s; when a plural number is used, this refers to the same five functional components associated with the five REDWs.) NEDW can have 2, 3, 8 or n number of REDW nodes. The network topology of the five REDW diagrammed nodes is in a dispersed layout forming a simple ring. Each REDW node in the simple ring is adjacent to two other nodes.

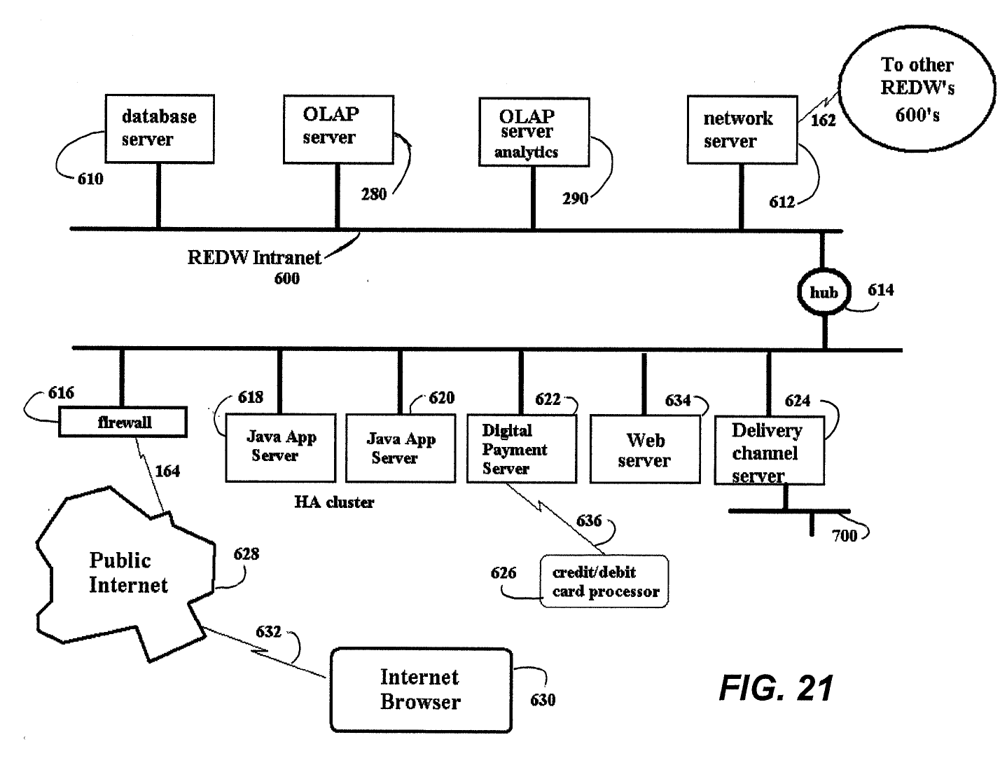

Inside the five REDWs are REDW Intranets 600A, 600B, 600C, 600D, and 600E. The specific operations and structure of a single REDW Intranet 600 is described in FIG. 21. The backbone of the NEDW network as shown in FIG. 2 are REDW network servers 612A, 612B, 612C, 612D, and 612E. The core functions of REDW network server 612 include sharing data communications traffic loads, load balancing, archival back-up of data, node address resolution, and disaster recovery. The five REDW Intranet 600s have Ethernet hubs 614A, 614B, 614C, 614D, and 614E, respectively.

NEDW creates completely new economic data with the z axis of expenditure categorization in FIGS. 1B and 1C. Within the five REDWs are storage databases 170A, 170B, 170C, 170D, and 170E, which house NEDW payments data. When payments data under this additional dimension from across the country is aggregated, analyzed and delivered on a near real-time basis, extraordinary computing and processing demands will test the integrity of the systems architecture.

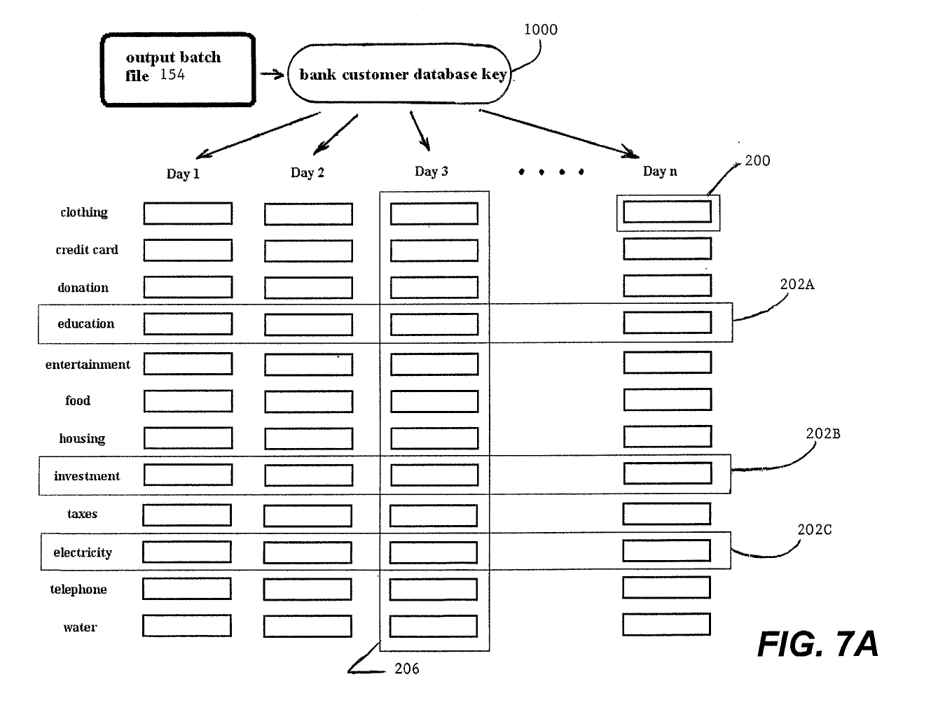

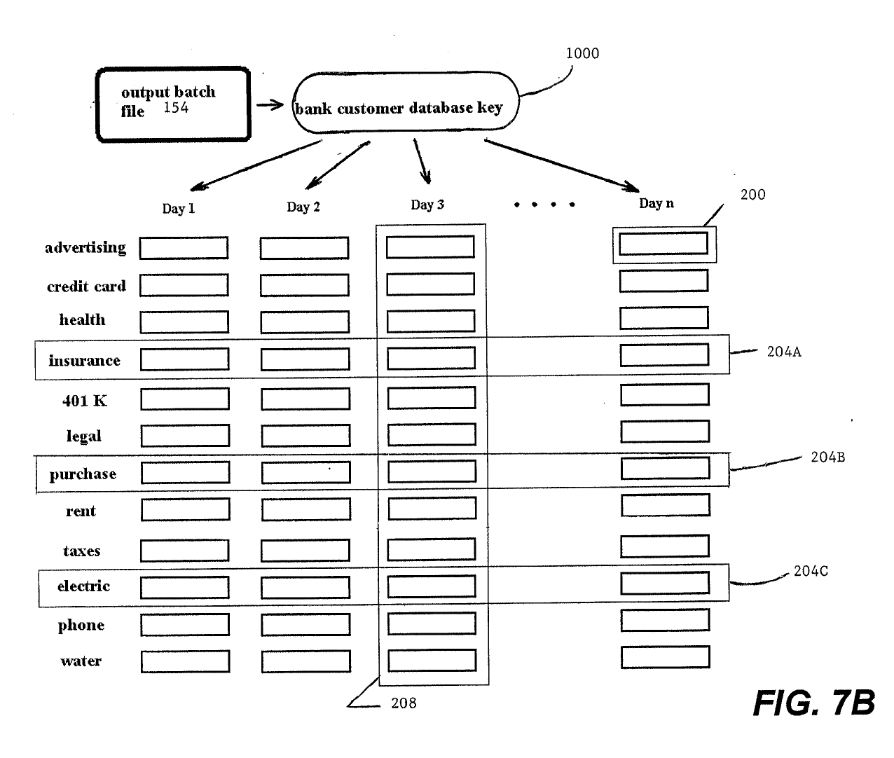

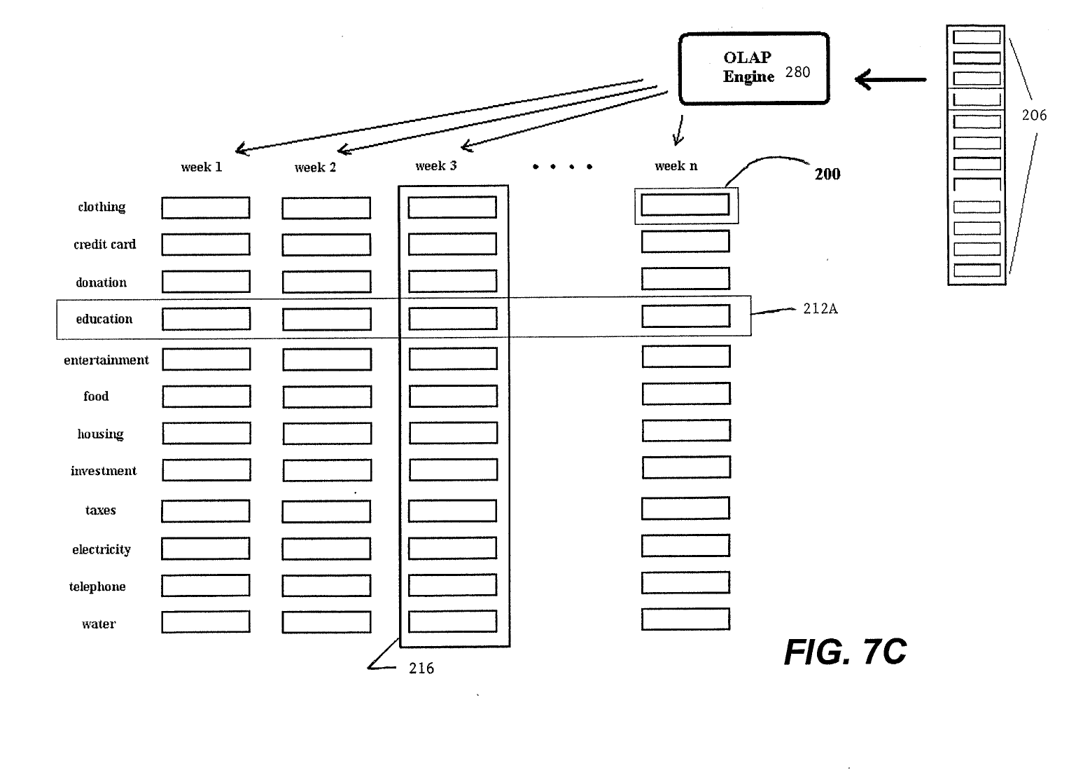

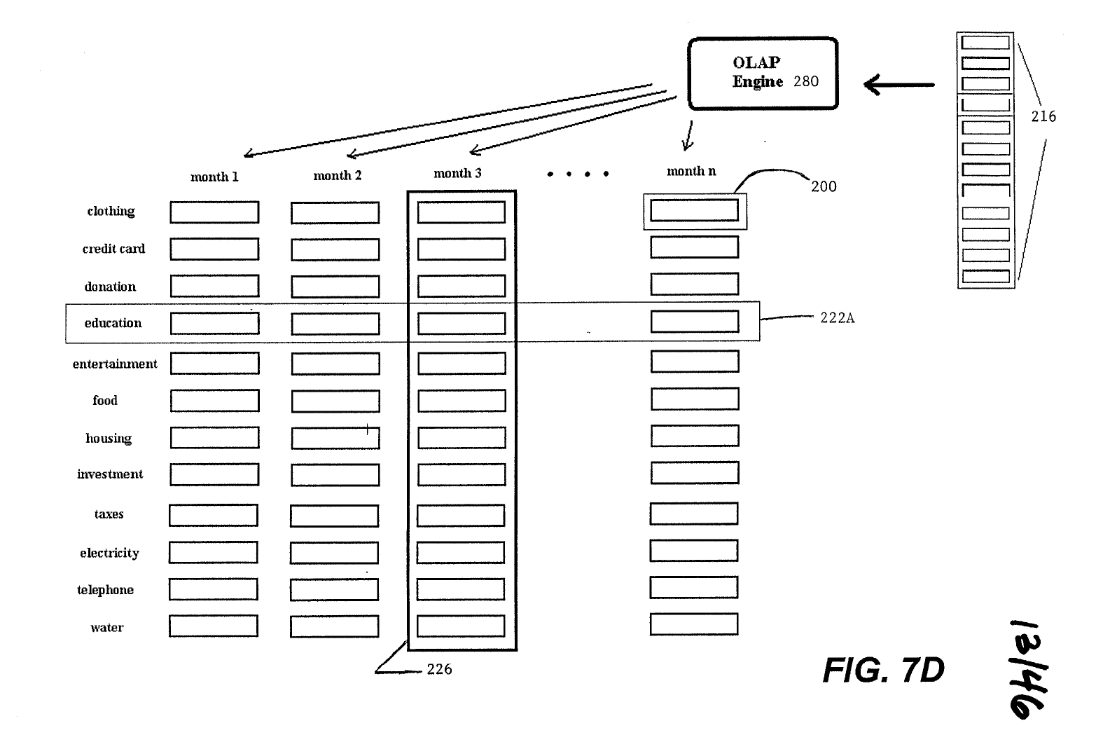

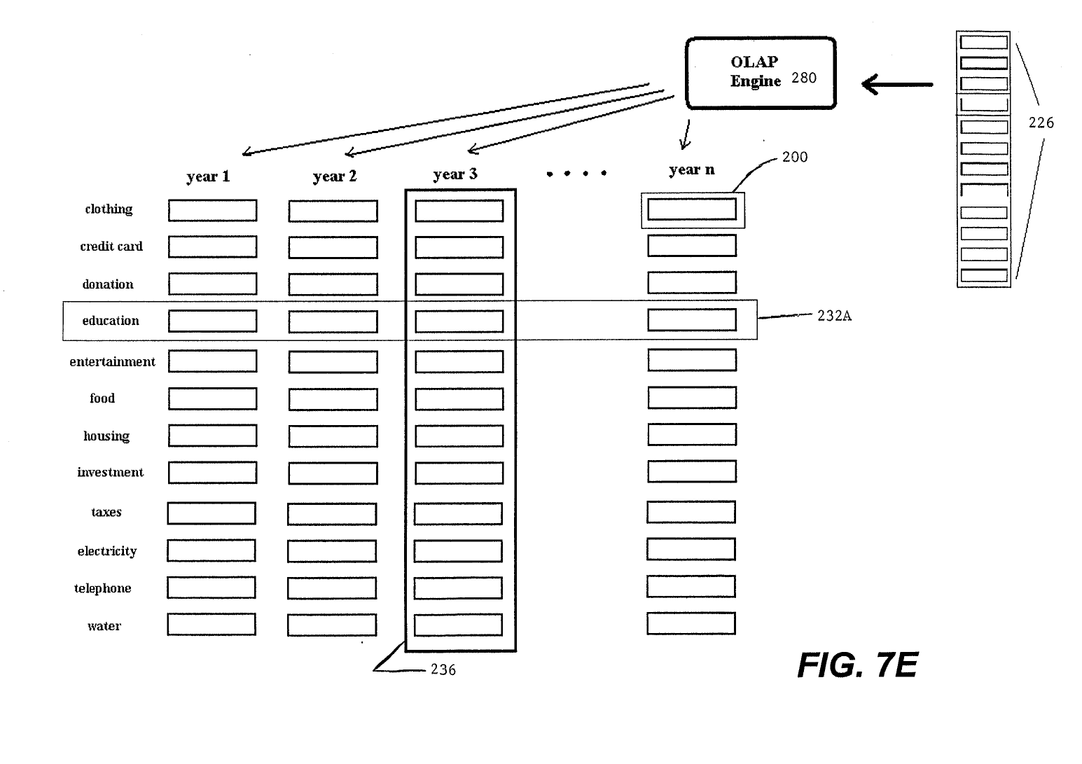

Effective and optimal use of NEDW is realized only with multi-dimensional data analysis, also known as on-line analytical processing (OLAP). NEDW historical expenditure data is stored and indexed in a relational database. A Structured Query Language (SQL) interface facilitates data requests of an OLAP query against one or more REDW nodes. Inside REDW Intranet 600s, OLAP queries are serviced by OLAP servers 280A, 280B, 280C, 280D, and 280E, and by OLAP server with predictive analysis 290A, 290B, 290C, 290D, and 290E. This architecture provides provide high availability clustering. Other, more exhaustive and deeper searches into NEDW may require access to multiple REDW nodes and more CPU and I/O time. CPU time increases with the complexity of the OLAP query. I/O time increases with the length of each of the three basic NEDW dimensions of time, expenditure category and customer aggregation. More I/O time must cover the processing and analysis of additional rows, columns, layers, slices and sheets as described in FIGS. 7A to 20 within the NEDW data hypercube.

Returning to the network architecture in FIG. 2, high speed dedicated digital data trunks 162A, 162B, 162C, 162D, and 162E connect the five REDWs. NEDW enduser demand and the complexity of NEDW OLAP queries returned through the Internet 628 and Internet browser 630 will dictate trunk allocation. As a private network, NEDW will operate over TCP/IP with standard network protocol stacks. Dedicated and private data trunks provide a more secure channel to pass OLAP queries and corresponding results through the NEDW network. Multiple REDW nodes as depicted in FIG. 2 provide a high availability solution. If one REDW node has a power failure and burdens one of network server 612s, the remaining four REDW nodes operate at less than optimal speed, but can still process OLAP queries against NEDW. More complex routes implies more network traffic allocation algorithms and proportionately, more heuristic, non-productive work done by each network processor at each REDW node. Optimization and constraints of NEDW networking depend on the number and bandwidth of the data trunk 162s between the REDW nodes and the connectivity between adjacent nodes.

Alternative network design for NEDW uses a mononode or monolithic network systems architecture, which eliminates the need for multiple network servers and dedicated, private high speed digital data trunks. Network administration is far simpler. However, a single point of network failure would be extremely disruptive. As REDWs increase and are geographically dispersed and as REDW storage database 170s grow, more complex mesh topologies for the overall network are required. This accommodates for diverse and more robust network traffic load-balancing and routing of OLAP algorithms to efficiently transport query and result sets. Network architecture for NEDW ultimately depends on a consensus among multiple payment processors and NEDW endusers throughout the U.S.

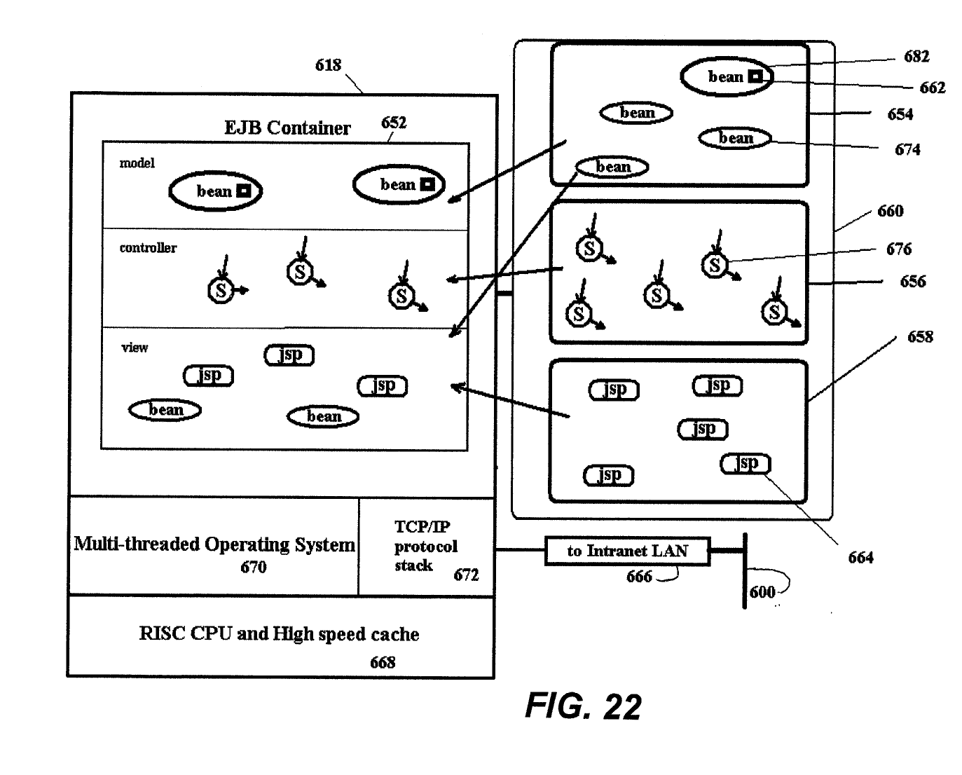

NEDW endusers can remotely utilize NEDW through public Internet 628, represented by an oval in the center of FIG. 2. Internet 628 is typically an ISP (Internet Service Provider) providing immense bandwidth and uptime availability to NEDW network infrastructure. An individual enduser gains access with personal Internet browser 630 view an enhanced e-Portal site. Operations of the site are detailed in FIG. 22. As multiple endusers log into the NEDW e-Portal to glean and extract meaningful historical data spanning months and years, network bandwidths will enlarge to adequately satisfy the demand for timely, accurate economic data on expenditures by consumers and businesses.

For basic security between the five REDW 160s are firewalls 616A, 616B, 616C, 616D, and 616E, respectively. Firewalls provide not only IP address substitution and programmed IP filters, but also protection against outside spoofing, Trojan Horse malfeasance, and virus penetration from public Internet 628. More robust versions of each REDW firewall include DMZs (demilitarized zones) and URL (Uniformed Resource Locator) filtering. At each REDW, high speed digital trunks 164A, 164B, 164C, 164D, and 164E provide a direct connect between its respective firewall 616 and public Internet 628. High speed data interconnect 166A, 166B, 166C, 166D, and 166E run on-premise fiber/copper wiring from firewall 616s to NEDW Intranet 600s.

Also within the five REDW nodes are digital payment servers 622A, 622B, 622C, 622D, and 622E. Further details on server 622 are found in FIG. 21. Server 622 calculates a fee for each OLAP query and collects client information from NEDW endusers. One form of e-commerce payment accepted is a digital payment mechanism using secure sockets and absolute security and encryption of the credit/debit card numbers transmitted over the Internet. The latest type of this sensitive information involves several levels of cryptography to stymie and effectively thwart any snooping and pirating of personal financial information.

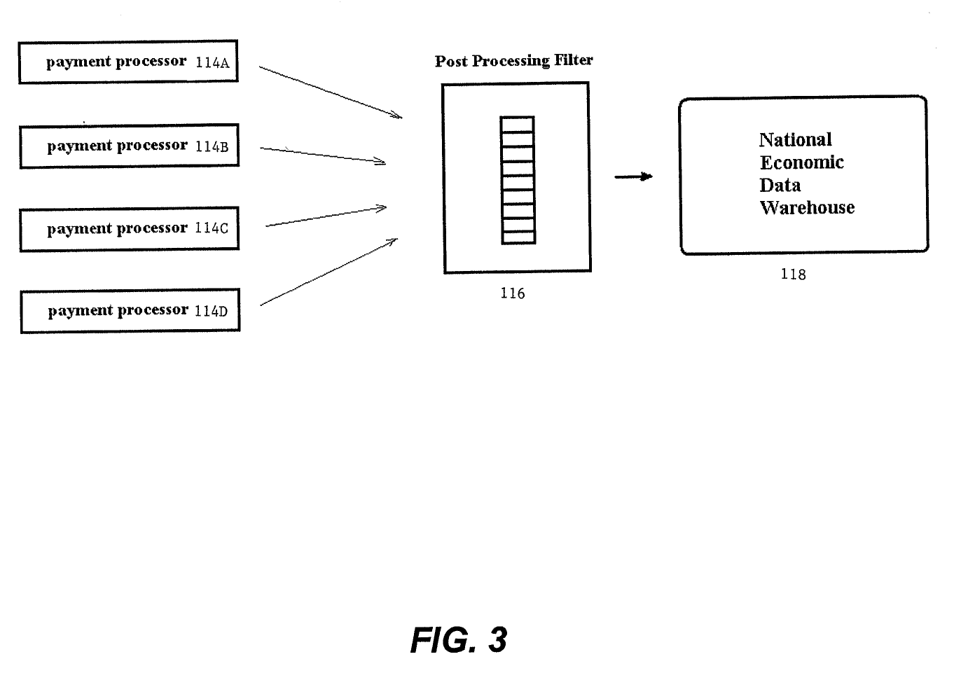

FIG. 3—Post-Processing Filters Inside the System

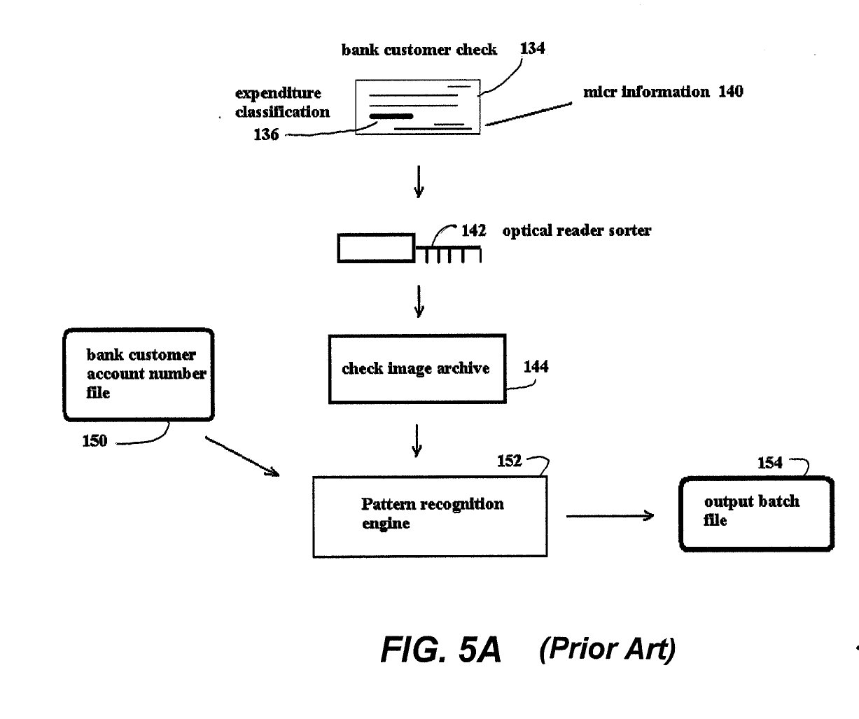

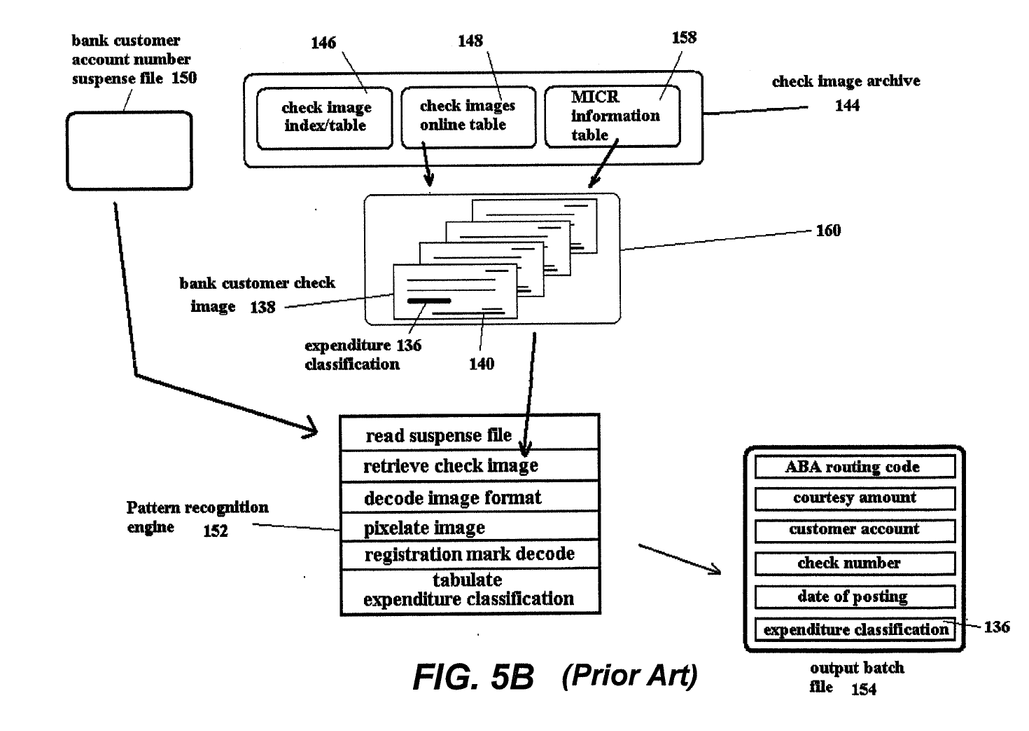

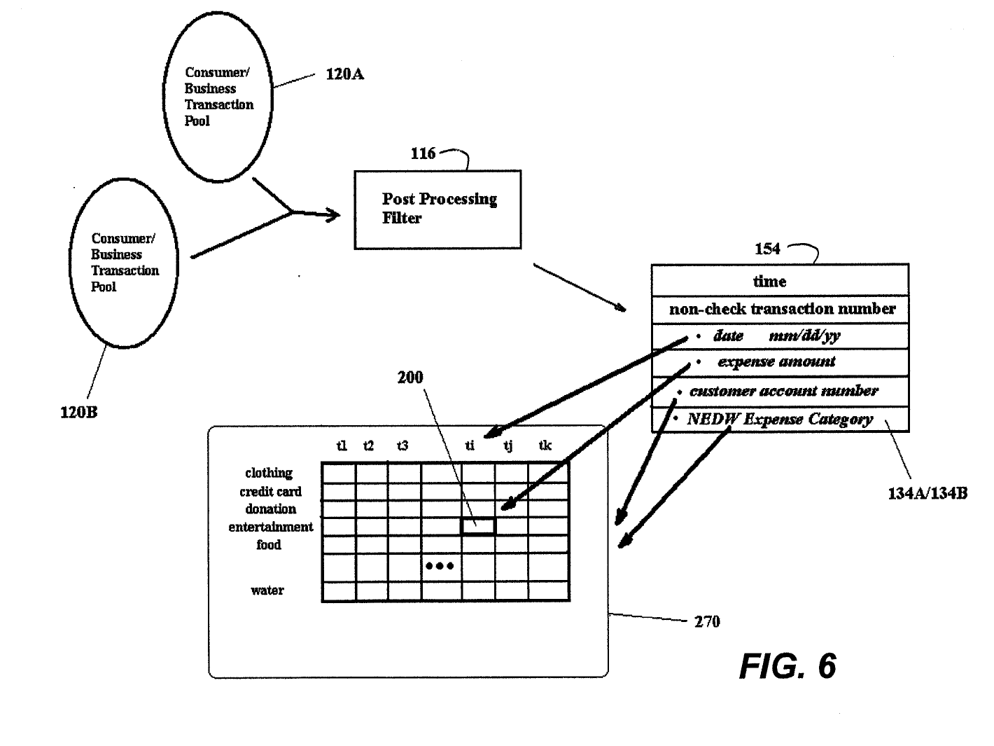

In FIG. 3, payment transaction records flow from various payment processors. Previously processed payment transaction records may already contain spending classification codes, The key indexible field inside post-processing filter 116 is an assigned universal expenditure category, chosen from either a universal consumer set of categories or a universal business set of categories. Payment processor 114A is a credit card association that assigns spending classifications based on Standard Industrial Classification (SIC) codes. Payment processor 114B is a demand deposit account system of a bank. The population of charges against a checking account includes checks, debit card transactions, online banking transactions with electronic bill-pay and other debit items. For debit cards, the bank may likewise use the SIC code. Or, the customer may use an online banking program to classify the payment. Payment processor 114C are financial payment intermediaries such as CheckFree, which receives instructions for account holders to issue paper checks to their designated payees. This processor may have independent systems of classification or no system at all for the account holder. Payment processor 114D could accept uploaded payment transaction data from smart cards and from PCs with installed PFM (Personal Financial Management) software. Post-processing filter 116 yields output batch file 154s in FIGS. 5A, 5B, and 6. Payment transaction data fills various data cells inside the NEDW 118 hypercube.

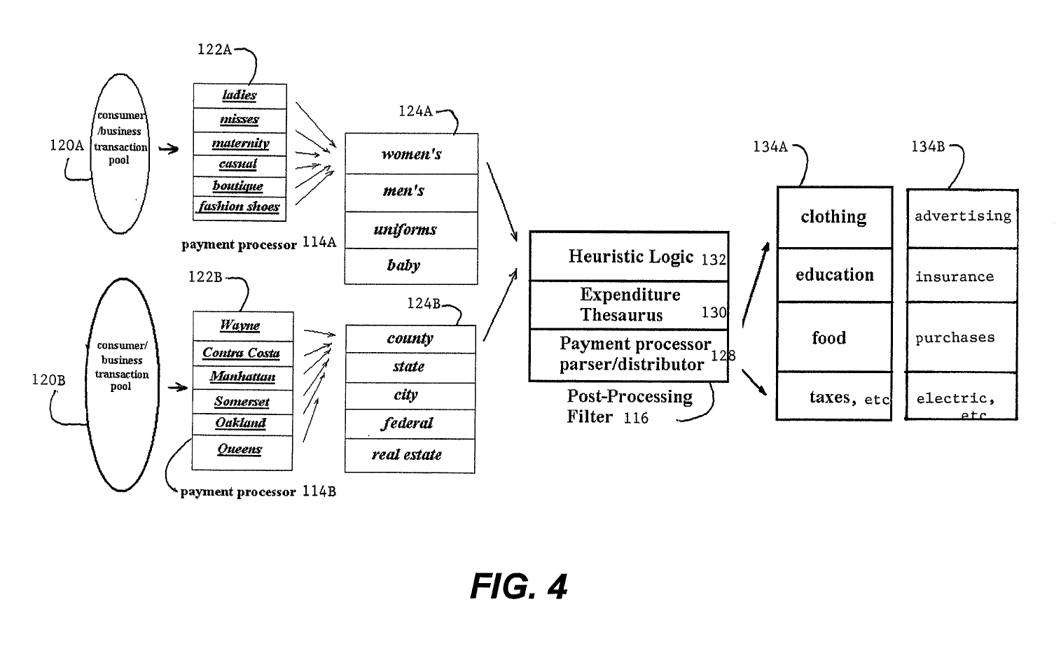

FIG. 4—Detailed Operation of the Post-Processing Filter

In FIG. 4, post-processing filter 116, which is installed at the physical data center of NEDW, contains three software modules. Payment processor parser/distributor 128 reads each consummated payment transaction and its line items or services purchased. The internal parser finds out the date of the transaction, the amount of the transaction and keeps track of the various line items, separating out the taxes, shipping and handling, and gratuities. Payment processor parser/distributor 128 writes the transaction amount, transaction date and an NEDW category as an output batch file. Output batch file 154s appearing in FIGS. 5A, 5B and 6 are then transmitted across digital data trunk 162s found in FIG. 2 to the appropriate REDW node and archived into NEDW. Expenditure thesaurus engine 130 contains a means to convert different terminology for a good or service into a particular broad category. It links the spending classification code text to one of a universal expenditure category using an expenditure thesaurus of all known and available expenditure categorization. Heuristic logic 132 performs the final step of assigning a transaction with a single choice out of NEDW expenditure category set 134. It matches a root word of a spending classification code text to a root word of a key word identifying a specific NEDW universal expenditure category. Further, it groups unmatched and unlinked spending classification codes according to groupings of subcategories under NEDW universal expenditure categories. If a spending classification term has not been previously recorded for a previously processed payment transaction record, post-processor filter 116 may use the payee's name in the record and ascertain the type of business of the payee to assign a universal expenditure category.

Payment processor 114A has six spending classifications for accepting clothing transactions. Transaction pool 120A flows into payment processor 114A, a credit card association, which uses expenditure table 122A to assign a spending classification code to each payment transaction record according to the merchant's SIC code. As new business types emerge and erode, the merchant codes would be updated either independently or concurrently with updates to SIC codes. Post-processing filter 116 runs heuristic logic module 132 to collapse various nomenclatures for women's garments into a women's clothing classification under expenditure table 124A. Finally, heuristic logic 132 turns to NEDW consumer expenditure category set 134A to assign the filtered transactions with the clothing category.

Turning to payment processor 114B, expenditure table 122B shows separate classifications for six different county tax collecting districts. Consumer/business transaction pool 120B contains personal and business checks written for county taxes against their checking account maintained by payment processor 114B, which is a commercial bank. Post-processing filter 116 executes heuristic logic 132 and expenditure thesaurus 130 software modules to compare the payee names against expenditure table 122B. These are determined to be counties in the U.S. with the use of expenditure table 124B. Finally, payment processor parser/distributor 128 will assign the filtered transactions for county tax payments to taxes under NEDW business expenditure category set 134B.

Although post-processing filter 116 operates one central location, multiple filters could be distributed among REDWs and placed in multiple locations. The number and locations of PPFs depend on available CPU resources to insure veracity, timeliness and economies of scale to the enduser of NEDW data. In FIG. 3, payment processors 114A, 114B, 114C, and 114D can have their own dedicated post-processing filter or share post-processing filter 116 as shown. Multiple payment processors spread geographically would utilize a distributed network of PPFs. NEDW is relieved of the enormous processing responsibility of parsing out all of the incoming transactions and resolving the category impedance. Localized PPFs assume a front-end data scrubbing function. This leaves the very core of NEDW for data mining and related processing functions. This advantage is partially offset by the need for a central administrative function to oversee the distributed PPFs and the three underlying software modules in each PPF in FIG. 4.

FIGS. 5A and 5B—Paper Check Payments inside NEDW

FIGS. 5A and 5B present prior art under U.S. Pat. No. 5,433,483. FIG. 5A shows the mechanics behind a preferred embodiment to extract spending data from bank customer check 134. A bank customer opens a demand deposit account at a bank, which creates new unique account information as stored in bank customer account number suspense file 150. Prior to bank processing of check 134, paper checks are pre-printed with a marking system to enable the customer to categorize the check payment. When remitting check 134, the customer affixes a marking for a selected expenditure classification. During processing of check 134, optical reader sorter 142 captures a digitized image of check 134. Check image archive 144 stores the check images and retains relevant check transaction information. Pattern recognition engine 152 accepts transaction account information from both archive 144 and suspense file 150 to generate output batch file 154.

FIG. 5B details the functions of archive 144 and the principal steps of pattern recognition engine 152. Check image archive 144 has numerous components but the three of key interest are check image index/database 146, check images online table 148, and MICR information table 158. Check image index/table 146 provides logical addressing between table 148 and table 158. Index/table 146 is typically a subcomponent of vendor-specific RDBMS—relational database management system. Check images online table 148 stores all the check images. Out of MICR information table 158 for each check comes MICR information 140—ABA routing code, customer account number, courtesy amount and check number.

Archive 144 is the source of check transaction batch file 160 for processing by pattern recognition engine 152. Batch file 160 has for each check the following: check image 138; expenditure classification 138; and MICR information 140. Batch file 160 also has pertinent information such as check batch run, date of check posting, reader/sorter machine number and relevant information on each check. To produce each batch file 160, engine 152 first uses suspense file 150 to identify all accounts with the expenditure classification 136 feature. Then, engine 152 creates and sends a Structured Query Language (SQL) select statement to check image archive 144 that searches check image index/database 146 for matching check image 138. Once check image 138s are retrieved from check images online table 146, archive 144 places the requested check image 138 into both engine 152's own buffer and a temporary buffer inside archive 144. Archive 144 then retrieves the corresponding MICR information 140 from MICR information table 158. MICR information 140 is then moved to temporary buffers inside archive 144 and engine 152.

Pattern recognition engine 152 software runs in an SMP (symmetric multi-processor) or parallel processing environment to meet the tight schedules and millions of customers of larger banks. Engine 152 reads bank customer account number suspense file 150 for active bank checking accounts, separated between business and household consumer accounts. With check image 138 in hand, engine 152 performs the key function of decoding the physical mark made by bank customers on check 134 for an expenditure classification. Check image 138 falls into one of several formats, such as TIFF type 6, color JPEG and IBM ABIC, which are well-known industry standards. First, engine 152 pixelates the entirety of check image 138. A pixel represents the smallest computational unit of the computer graphics image. The number of pixels in an image ranges from 25 to 200 pixels per linear inch and 625 to 40,000 pixels per square inch. Higher resolution results in greater accuracy. Greater digital image resolution requires greater buffering and addressing within the image processing buffers. Next, engine 152 uses heuristic pattern recognition to capture of leading and trailing registration marks. These marks are reference points to measure the interval between the customer's physical marking and the registration mark on check image 138. Next, engine 152 determines which expenditure classification 136 is marked based on the length of the interval. Finally, engine 152 assigns and accumulates assigned expenditure classification 136 for all check transactions inside batch file 160. Output batch file 154 contains the data files as shown in FIG. 5B. The key item created by engine 152 is expenditure classification 136. If the expenditure classification 136 set mirrors NEDW universal expenditure categories 134A and 134B for consumer and business payments as the case may be, output batch file 154 may bypass to post-processing filter 116 in FIGS. 3 and 4. If expenditure classifications 136 do not mirror categories 134A and 134B, output batch file 154 passes through PPF 116.

FIG. 6—Non-Paper Payments inside NEDW

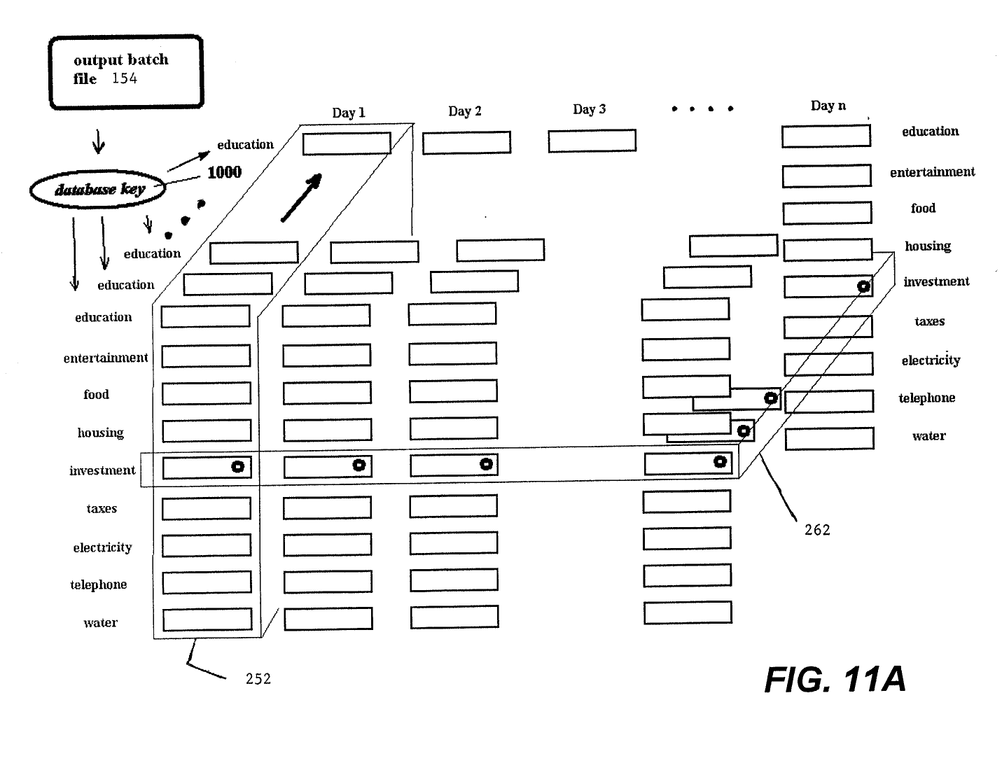

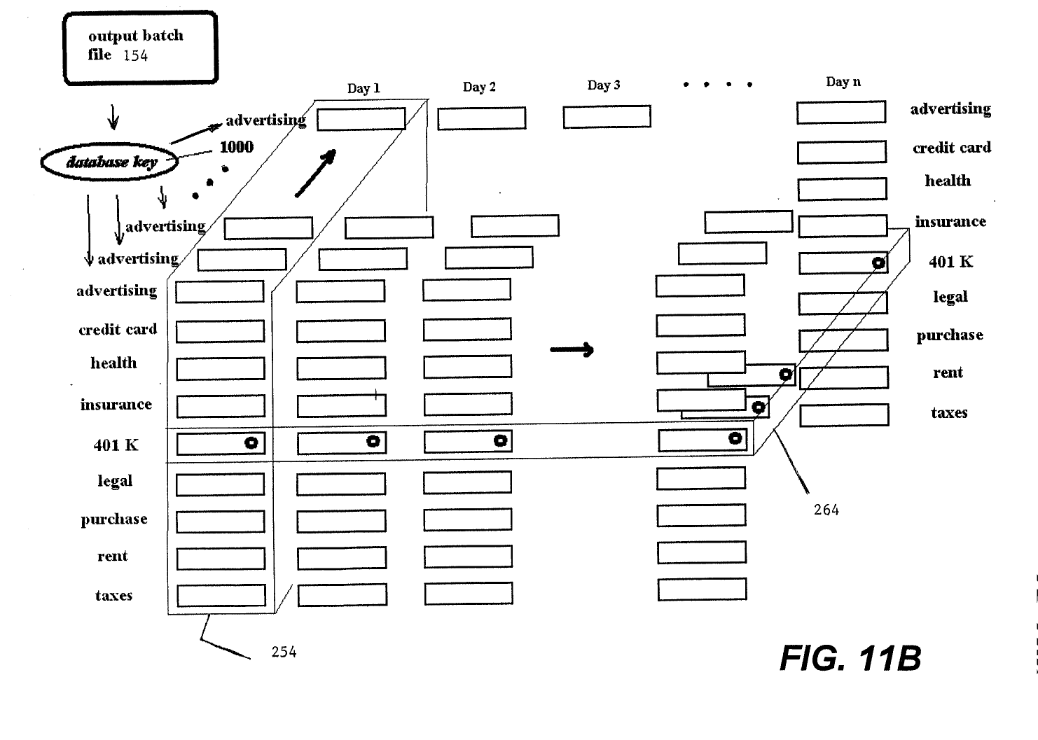

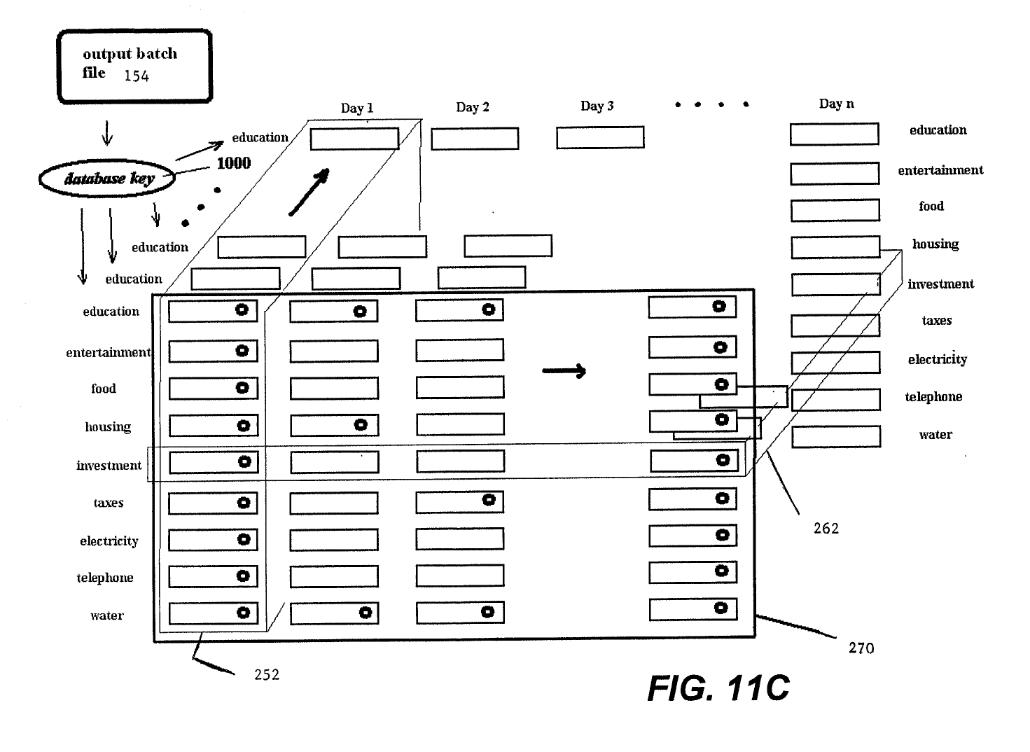

In FIG. 6, non-paper check transactions 120A and 120B enter post-processing filter 116, which locates appropriate NEDW universal category found in tables 134A and 134B in FIG. 4. Output batch file 154 emerges with the transaction date, payment amount, and NEDW expenditure category 134A/134B. NEDW data cell 200 is then properly valued and populated. As multiple cell 200s for a specific customer populate, micro customer sheet 270s are created as shown in FIG. 11C. Post-processing filter 116 contains NEDW expenditure normalization logic to equalize payment data handling across different and diverse financial transaction delivery channels.

FIGS. 7A through 10C—The First Two NEDW Dimensions of Expenditure and Time

NEDW is the aggregation of multiple payments of multiple customers. NEDW is partitioned between consumer payments and business payments. Accordingly, FIG. 7A presents the construction of the expenditure matrix for a single consumer, and FIG. 7B is a similarly designed expenditure matrix for a single business. The vertical dimension (z axis) is the column of the invention's universal consumer expenditure categories, and the horizontal dimension is time elapsed from left to right. On a daily basis, output batch file 154s feed the expenditure matrix of consumers and businesses with payments data. The smallest unit inside NEDW is a single payment, NEDW data cell 200, appearing in FIGS. 7A and 7B.

Each payment record in input batch file 154 has payer database key 1000. The key enables accurate placement of NEDW payment data inside the correct data cell 200. The primary component of key 1000 is customer identity for the payer behind the record. Customer identity allows for locating the correct micro customer sheet 270 in FIG. 11C in which to deposit the payment data. Where the primary key component is empty, key 1000 will move to the foreign component key which corresponds to NEDW x axis of time and foreign component key which corresponds to NEDW y axis of expenditure category. This at least places the payment transaction amount in a non-personalized file of micro customer sheet 270s.

In FIG. 7A, cell 200 as boxed is a single payment for clothing by a single consumer on Day n. In FIG. 7B, cell 200 is a single payment for advertising by a single business on Day n. The actual content of an NEDW data cell 200 is the value of the payment. In the case of check 134 processed and imaged by the system described in FIG. 5A, its courtesy amount is read from bank check MICR inside output batch file 154 in FIG. 5B.

FIG. 7A identifies three selected expenditure row vectors—education 202A, investment 202B and electricity 202C—of a single consumer. Expenditure row vector 202A is comprised of n number of NEDW data cells 200 based on an accumulation of education payments made of a series of days, from Day 1 to Day n. Bank customers with infrequent payments will have numerous NEDW Data cell 200 values of zero. As NEDW grows, careful systems management of disk and memory utilization will maintain the order, layout and number of cells from escalating beyond control. Total spending for a given day by the consumer is shown as time column vector 204. Similarly, FIG. 7B identifies three selected business expenditure row vectors-insurance 204A, rent 204B, and electricity 204C—of a single business. Total spending for Day 3 emerges from time column vector 206.

FIG. 7C show the aggregation of daily time column vectors for consumer payments into weekly time column vectors. This column shown aggregates all payments of a consumer, regardless of category. FIG. 7D aggregates weekly time column vectors into a monthly time column vector. FIG. 7E shows show monthly time column vectors are combined to arrive at a yearly column vector.

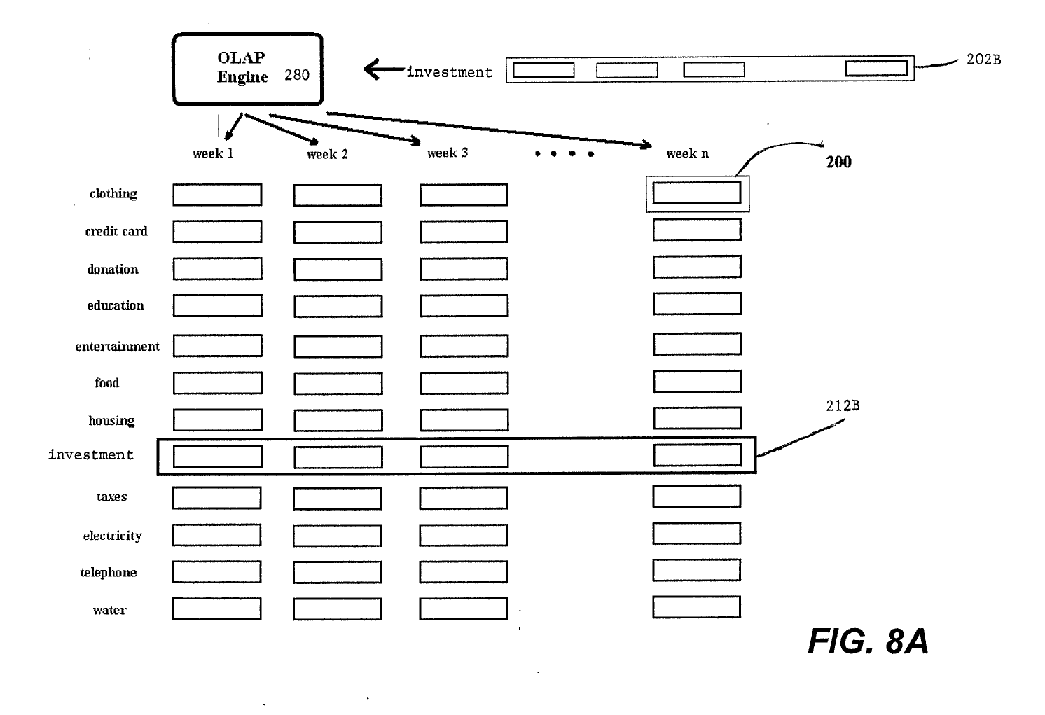

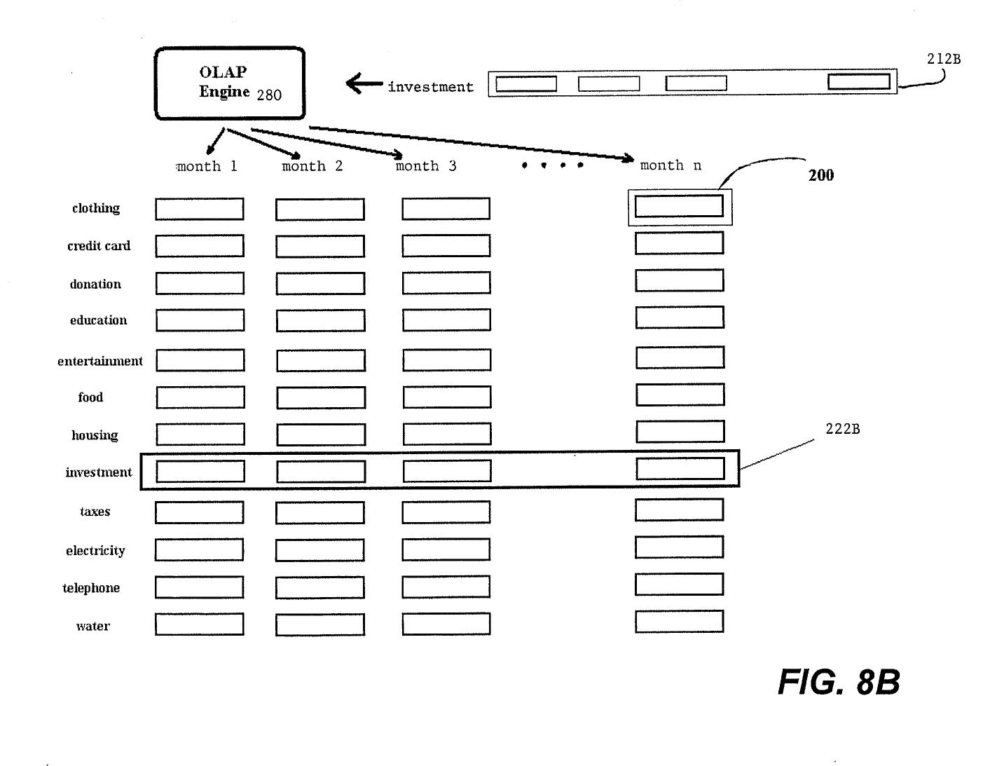

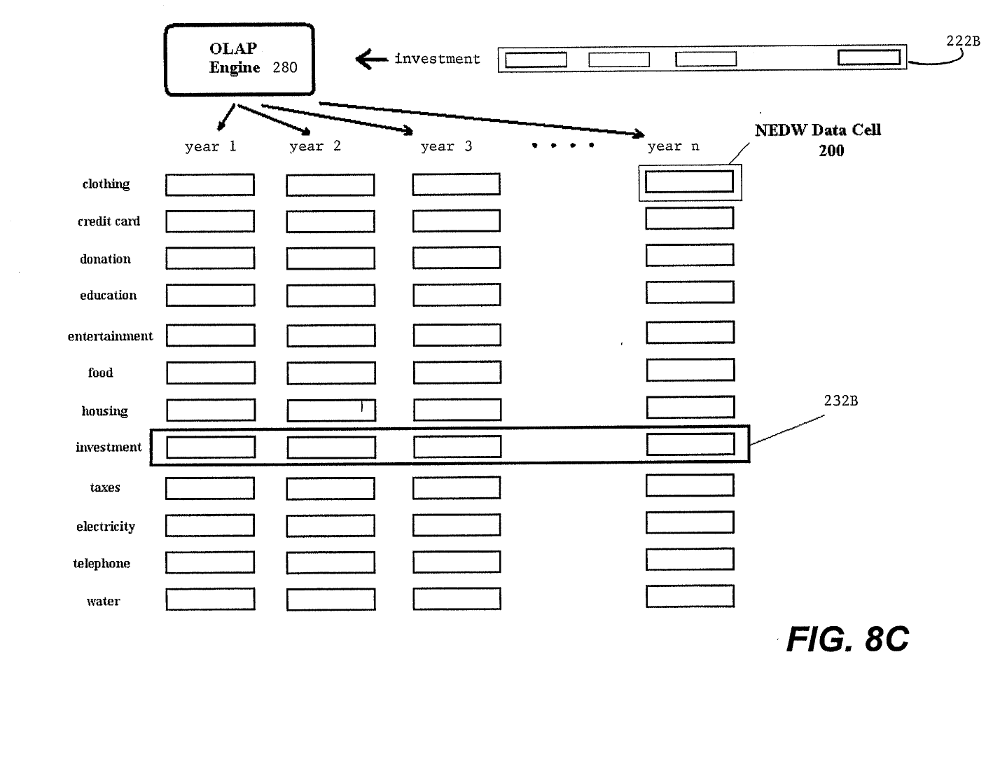

The next logical step with the time dimension is to accumulate distinct expenditure row vectors of a single customer. FIGS. 8A, 8B, and 8C show OLAP engine 280 accumulating the selected consumer expenditure category of investment in the respective groupings of days into weeks, weeks into months, and months into years. In FIG. 8A, totals of investment expenditures from Day 1 to Day n to generate a seven-day week under expenditure row vector 202B. Weekly investment expenditure row vector 212B flow into monthly investment expenditure row vector 222B in FIG. 8B. Vector 222B then flows into yearly investment expenditure row vector 232B in FIG. 8C. In each case, OLAP engine 280 returns accumulated total dollar spending under investments for the customer over designated time intervals.

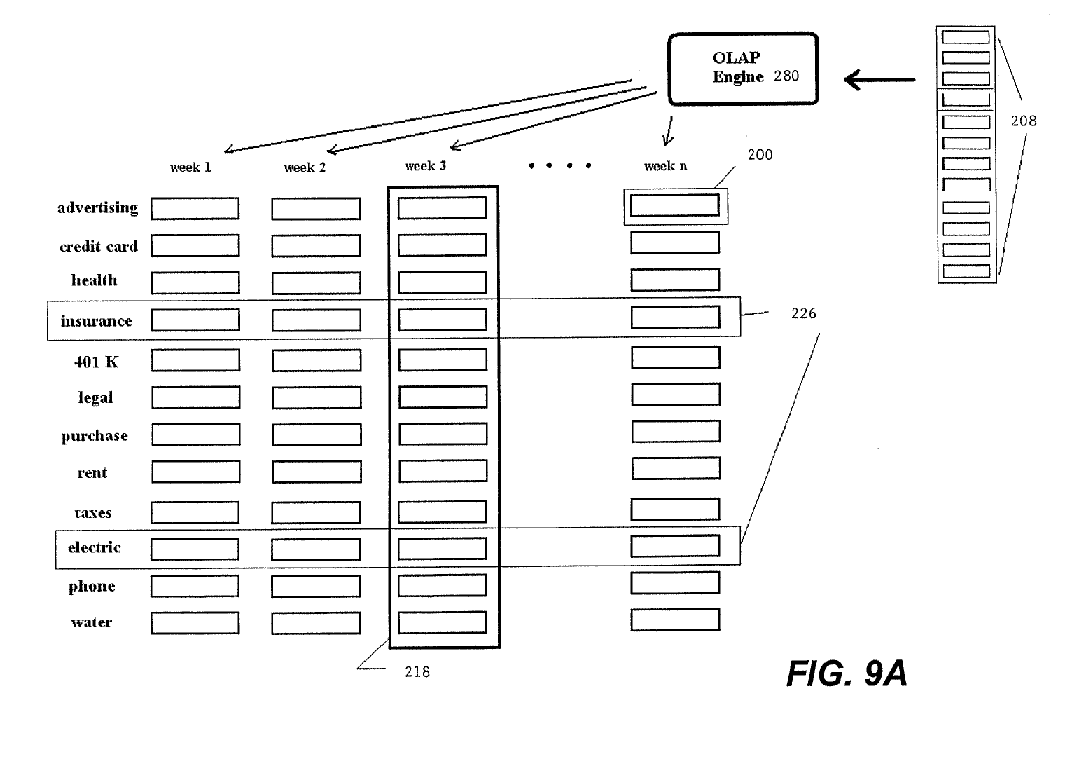

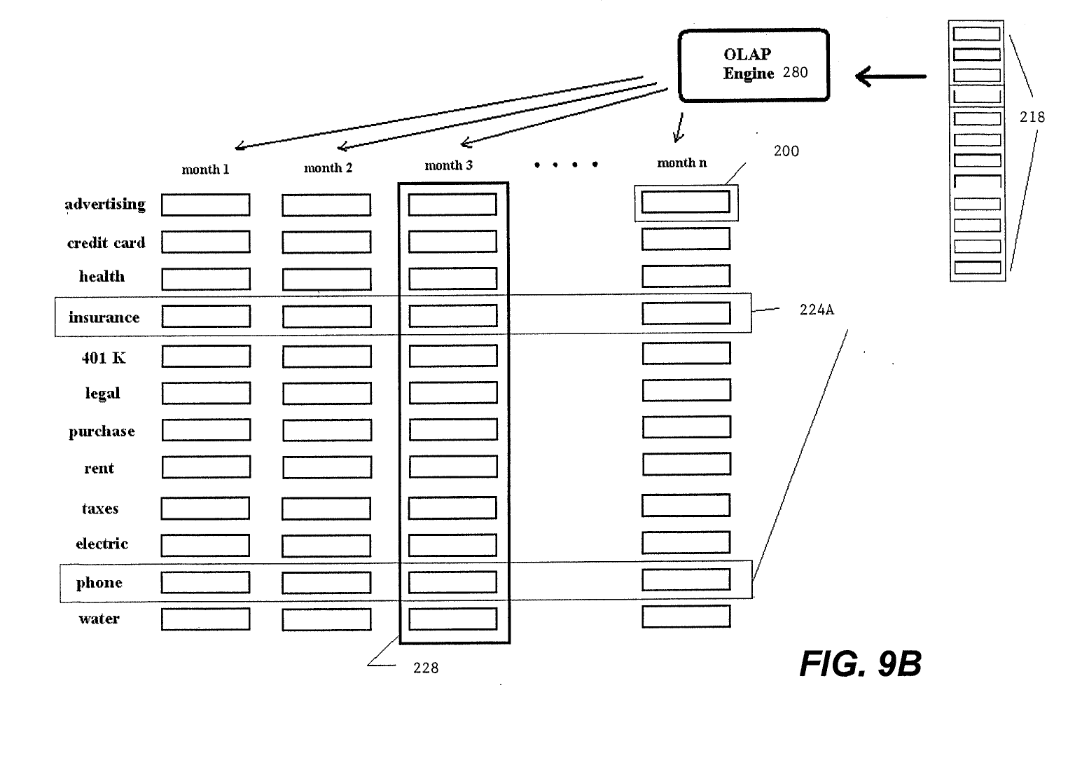

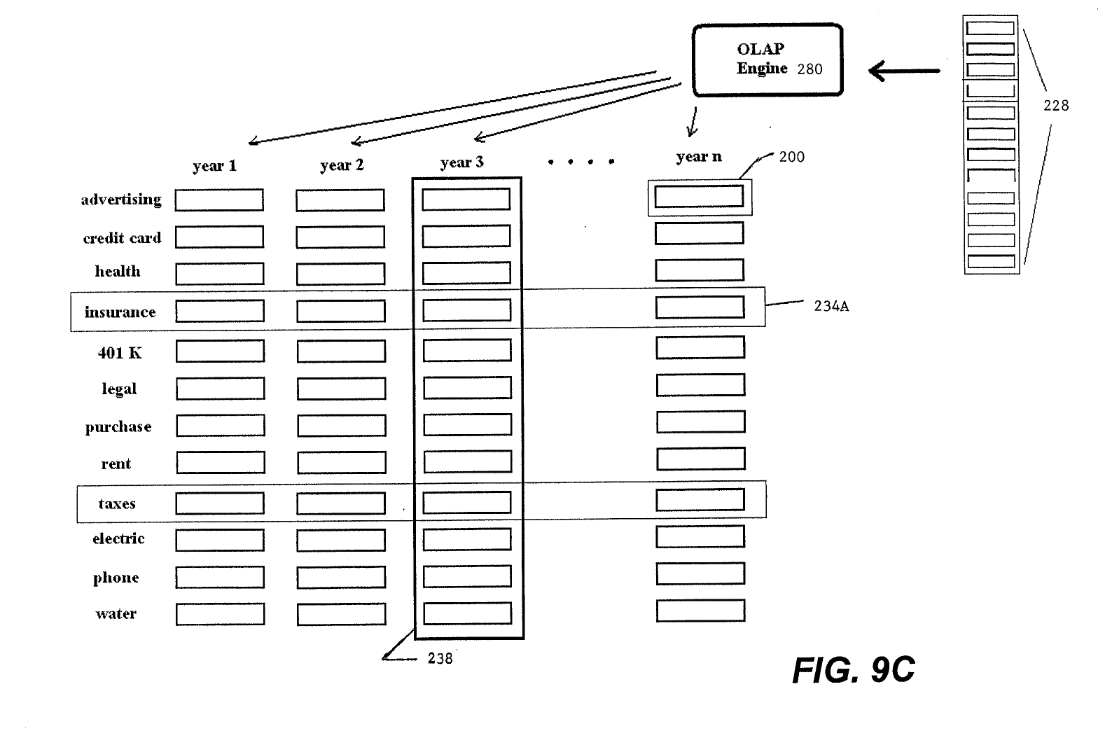

Accumulation of spending over time for all (as opposed to specific) expenditure categories by a single customer is a further available function. In FIGS. 9A, 9B, and 9C demonstrate how spending of a business, by way of example, is accumulated. In FIG. 9A, OLAP engine 280 accumulates daily time column vector 208 from FIG. 7B to generate weekly time column vector 218 for week 3. In FIG. 9B, engine 280 totals weekly time column vector 218 to yield monthly time column vector 228 for month 3. FIG. 9C shows engine 280 accumulating sufficient monthly time column vectors 228 to produce yearly time column vector 244 for year 3.

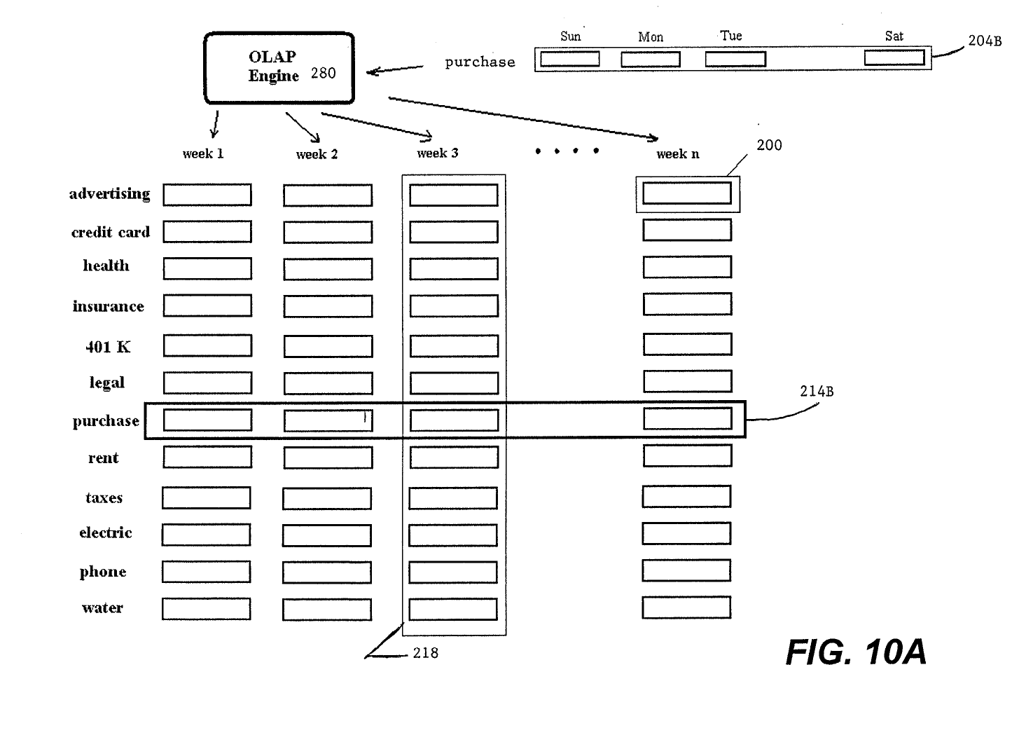

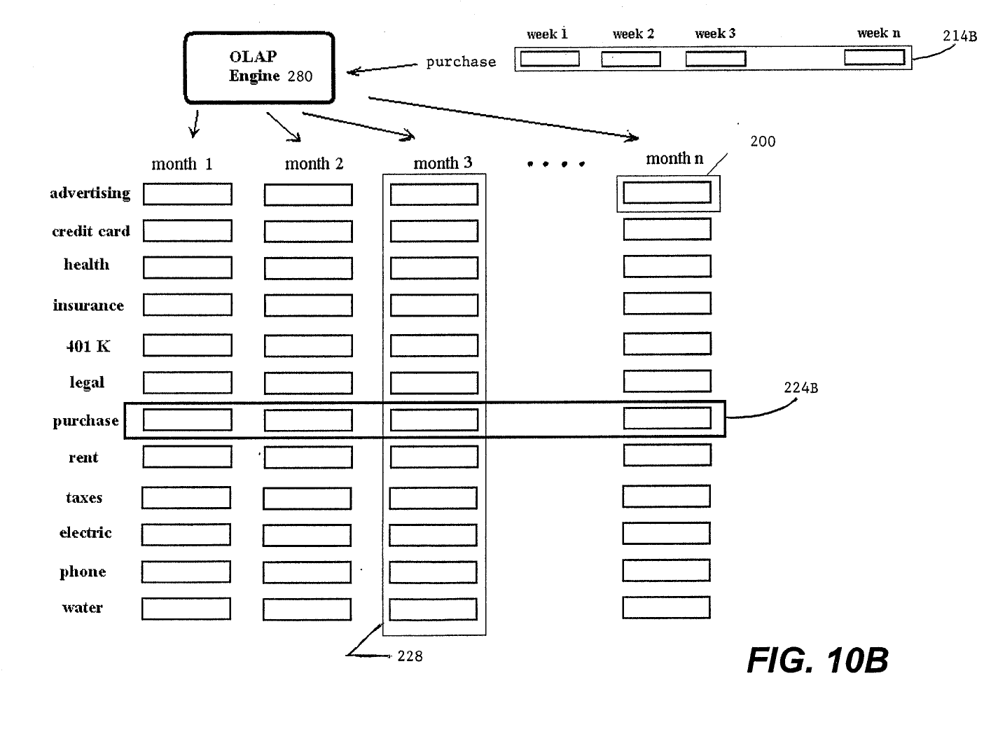

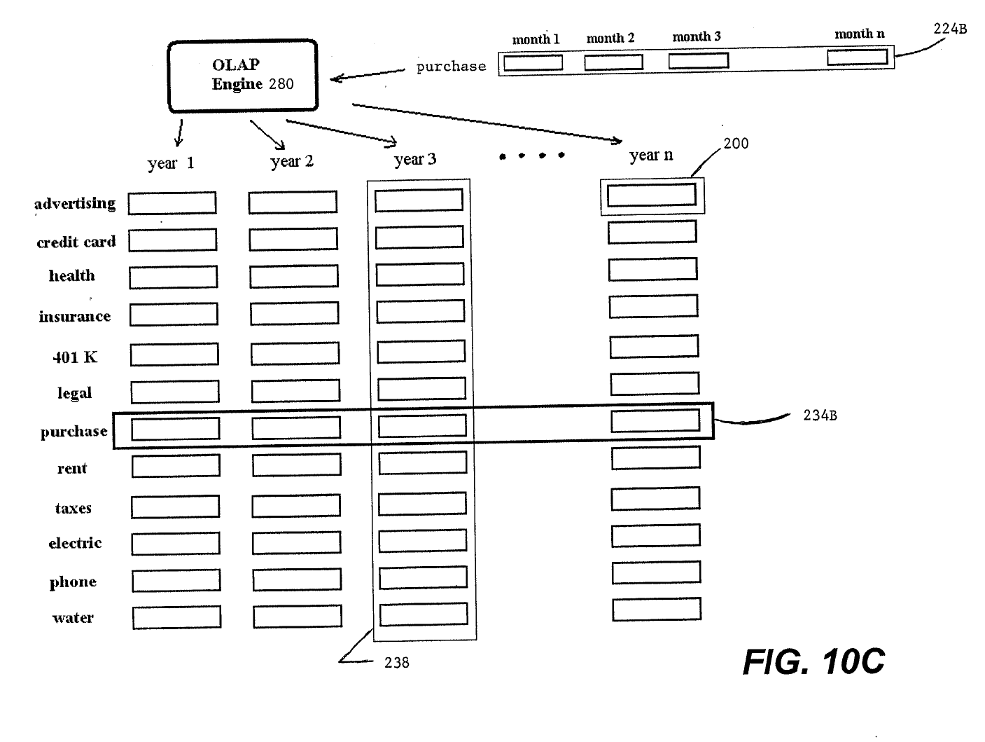

In FIGS. 10A, 10B, and 10C OLAP engine 280 follows the time dimension of spending under a specific expenditure category, but this time for a single business customer. For a business' purchase expenditures, OLAP engine 280 in FIG. 10A takes daily purchase expenditure row vector 204B from FIG. 7B to create weekly time purchase expenditure row vector 214B. FIG. 10B shows how weekly time purchase expenditure row vectors 214B generate monthly time purchase expenditure row vector 224B, and FIG. 10C shows how the process leads to yearly time purchase expenditure row vector 234B. The three figures also show how total spending of the business can be tallied—daily spending becomes weekly time column vector 218 (FIG. 10A), weekly spending becomes monthly time column vector 228 (FIG. 10B), and monthly spending becomes yearly time column vector 238 (FIG. 10C).

Customized time sequences can be calibrated by OLAP engine 280. For consumer payments, OLAP engine 280 in FIG. 8A can accumulate investment spending under vector 202B over a series of days less than a week. For business payments, in FIG. 10A, OLAP engine 280 can logically parse time vector 204A for a customized time period analysis of four days of a week. A business analyst can compare small business productivity in a selected geographic region based upon a full workweek with shorter workweeks when a national holiday occurs on a weekday.

FIGS. 11A through 11C—The Third NEDW Dimension of Customer Aggregation

Each of FIGS. 11A, 11B, and 11C shows output batch file 154 depositing NEDW expenditure data of multiple consumer and business customers. NEDW dimensional components discussed above are trivial incremental benefits to existing payments analysis. Categorizing and aggregating payments of a single economic unit is common to all bookkeeping and accounting systems. However, with universal categories in the vertical axis of consumer and business cubes of NEDW, OLAP engine 280 in FIGS. 8A, 8B, 8C, 9A, 9B, 9C, 10A, 10B, and 10C are poised to create an unprecedented source of macroeconomic consumption data. By moving along the customer identity y axis as shown in FIG. 1B, NEDW accumulates sheets of customer payments data marked by universal category.

In FIG. 11A, consumer payments data regardless of category for Day 1 of multiple consumers yields macro time slice 252. This is the equivalent of a bank's daily balancing of total customer checks and debits. Macro expenditure layer 262 represents the total investment expenditure made by multiple consumers from Day 1 to Day n. NEDW has been meticulously constructed and filled with payments data, each marked by a single NEDW universal category. In totaling the investment payments of multiple consumers from Day 1 to Day n, macro expenditure layer for investments emerges. Due to the volume and diversity of payment transactions data from multiple customers and multiple payment processors, NEDW OLAP engines can generate highly sophisticated analysis of historical expenditure data.

In a similar vein for business payments, FIG. 11B is a sample three-dimensional layout of the business cube of NEDW. Macro time slice 254 is the total payments accumulated for a multiple of business customers. Macro expenditure layer 264 contains all 401 K payments of multiple businesses from Day 1 to Day n.

FIG. 11C shows a subsidiary function available to single institutions for specific customers. While NEDW depersonalizes the spending data of specific customers, it can generate individualized payment category statements for single customers. NEDW micro customer sheet 270 groups categorized payment transactions across time for a single customer. To leverage the value of NEDW data, the invention allows access to each micro customer sheet 270 with a unique database key corresponding to a customer. Output batch file 154 includes a separate field for customer database key. In the northwest comer of FIG. 11C, a series of downward black arrows signify the logical relationship between output batch file 154 and various Micro Customer Sheet 270s. This is a one-to-one correspondence between one record of output batch file 154 and each micro customer sheet 270. For example, for 10,000 customers, there will be 10,000 micro customer sheet 270s.

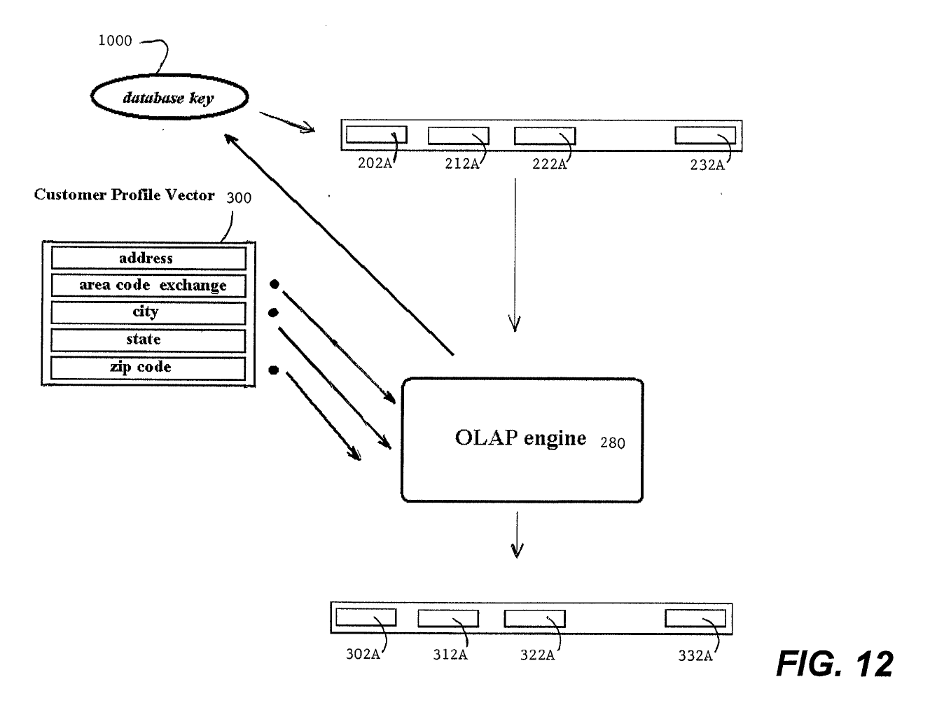

FIGS. 12 through 20—Processing Simple and Advanced OLAP Requests against NEDW

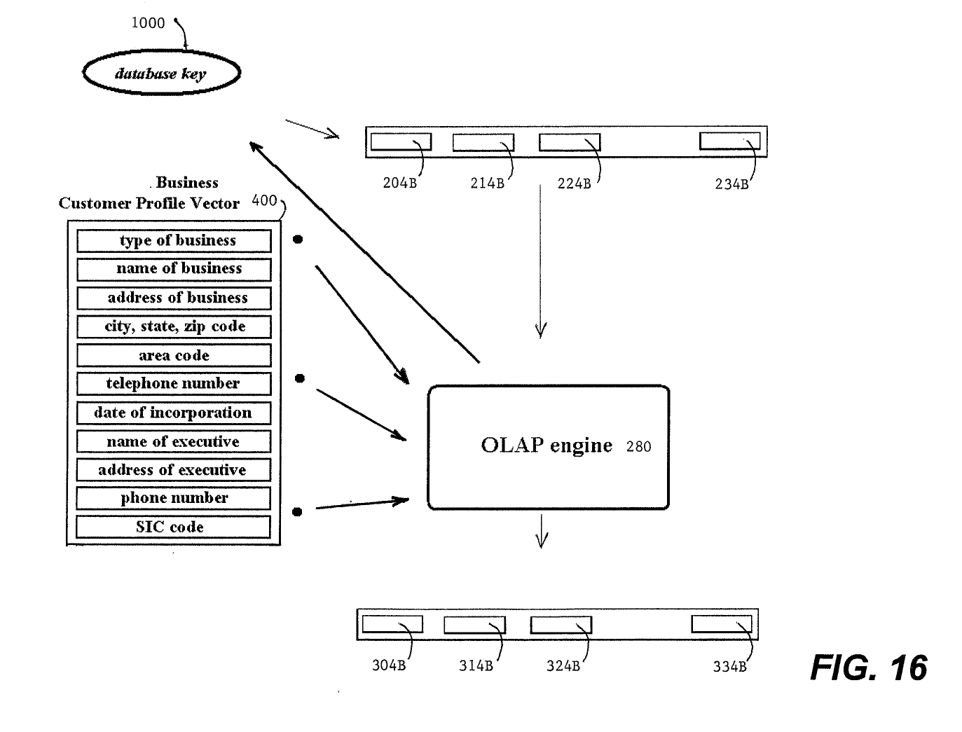

FIGS. 12 through 15 allow an NEDW enduser to search and analyze targeted data blocks within the consumer cube of NEDW, and FIGS. 16 through 19 repeat the process for the business cube of NEDW. In each case, the enduser enters database key 1000 to extract from the national warehouse certain data cell sets available. While other demographics may be known to banks and payment processors, NEDW restricts general usage to depersonalized data that prohibits individual identification of the consumer payer. This steers the invention clear of any privacy breaches or potential misuse of personal data.

FIG. 12 demonstrates how the consumer cube of NEDW containing expenditure data generates unprecedented macroeconomic analysis for an NEDW enduser. Since NEDW dynamically accumulates actual consumer payments data into universal categories, the enduser can query NEDW for basic OLAP analysis. NEDW enduser enters database key 1000 to initiate an OLAP query. Using consumer customer profile vector 300, the NEDW enduser presents input parameters against OLAP engine 280. Three specific consumer demographic parameters appear in vector 300—telephone area code and exchange, city, and zip code. In this case, the NEDW enduser happens to be a college recruiter of a major Midwestern university. For analysis of historical education payments, NEDW has education expenditure row vector 202A for selected days, vector 212A for selected weeks, vector 222A for selected months, and vector 232A for selected years. The recruiter wishes to analyze all education payments within a target zip code where parents of college recruits reside. OLAP engine 280 intelligently amasses qualifying NEDW data cells that fit customer profile vector 300 of zip code and the education expenditure row vector over time. The outcome for the desire zip code is output daily education expenditure vector 302A, weekly expenditure vector 312A, monthly expenditure vector 322A, and yearly expenditure vector 332A. Basic mathematical functions produce expenditure payment totals to compare against other zip codes.

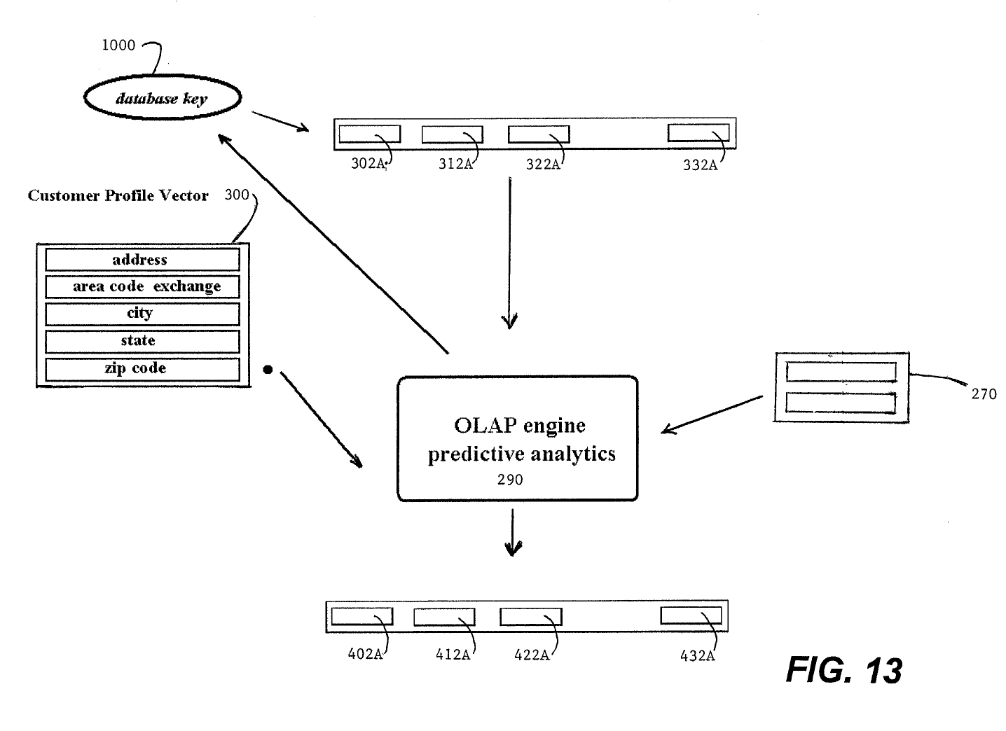

FIG. 13 illustrates the potential of using OLAP processing through multiple relational databases linked with NEDW. The college recruiter finds historical data insufficient to formulate a recruiting strategy. She turns to other demographic information that is relevant to the recruiting strategy. OLAP engine with predictive analytics 290 accepts as input education vectors 302A, 312A, 322A, and 332A. The raw historical totals spent on education in the desired zip code are far more useful if juxtaposed against population trends available from the U.S. census. OLAP engine 290 receives demographic input vector 270, which is the annual increase in number of family households for the specific zip code based on the latest U.S. census. Engine 290 can process the two input vectors to produce output vector for each of original NEDW vectors. Output vectors 402A, 412A, 422A and 432A are projections of educational spending for the zip code over a future day, week, month, and year, respectively.

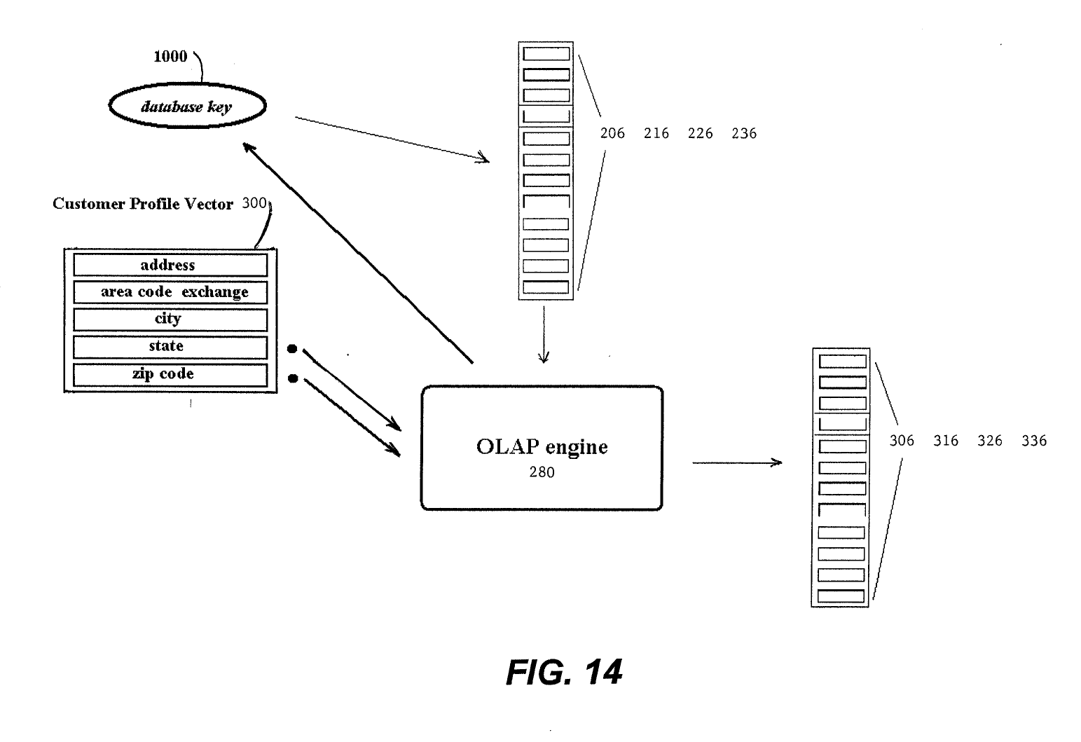

FIG. 14 is OLAP engine 280 at work with time column vectors for total as opposed to categorized consumer spending. NEDW contains total consumer spending for all 50 states over various time periods. A state economic planner using NEDW inputs parameters 500 for a specific state. OLAP engine 280 extracts the state's total consumer spending to yield time column vectors 406, 416, 426, and 436 for a particular day, week, month, and year.

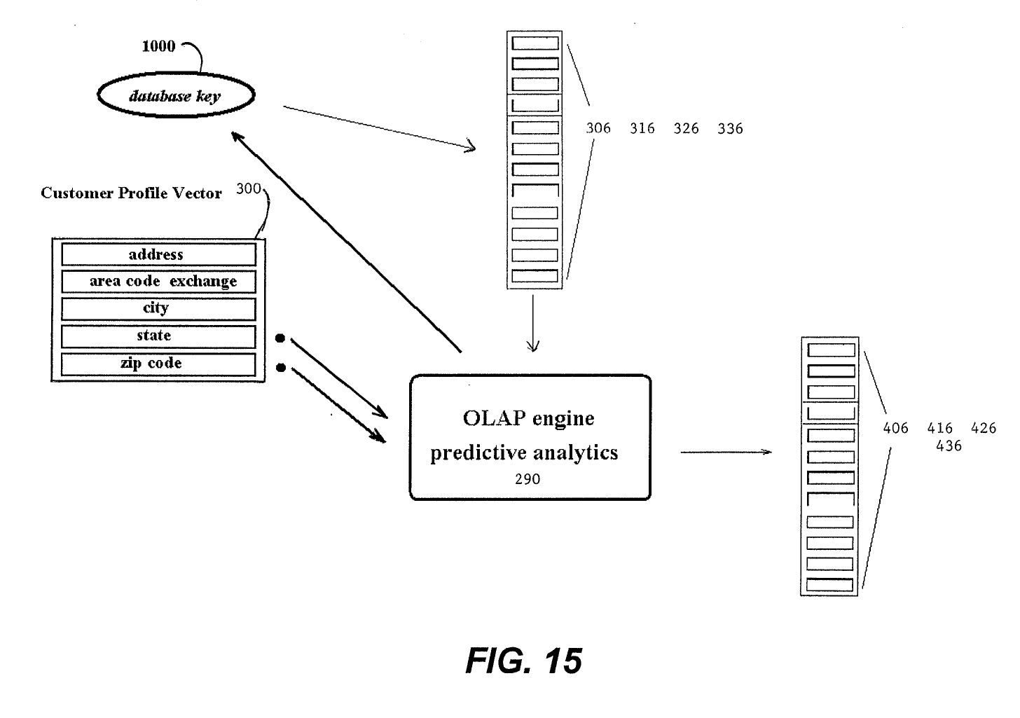

FIG. 15 shows how OLAP engine with predictive analytics 290 takes the extracted total consumer spending for a specific state and plots it against the Consumer Price Index for the time vectors under consideration by the state economic planner. The consumer spending is adjusted to reflect real versus nominal growth in consumer spending for the state. These adjusted amounts are shown as output time column vectors 406, 416, 426, and 436.

FIGS. 16 through 19 further demonstrate OLAP analytical functions with the business cube of NEDW. After entering database key 1000, NEDW endusers present input parameters from business customer profile vector 400. For policy reasons, access to business data is typically far more accessible than consumer data. The NEDW enduser chooses from a wide range of parameters and business elements in customer profile vector 400. In FIG. 16, input vectors for OLAP engine are purchase expenditure row vectors 204B, 214B, 224B, and 234B as shown FIGS. 7B, 10A, 10B, and 10C. Among business purchase total dollar volumes for all businesses nationally for the day, week, month, and year chosen, the NEDW enduser only desires purchases made by certain types of businesses. In FIG. 16, within business customer profile vector 400, the enduser enters SIC code for retail copy centers. OLAP engine 280 extracts from NEDW purchase payments made in this business retail segment only. These are shown as output vectors 304B, 314B, 324B and 334B. The NEDW enduser may ignore the type of business in the business profile and focus only on businesses in a single telephone area code.

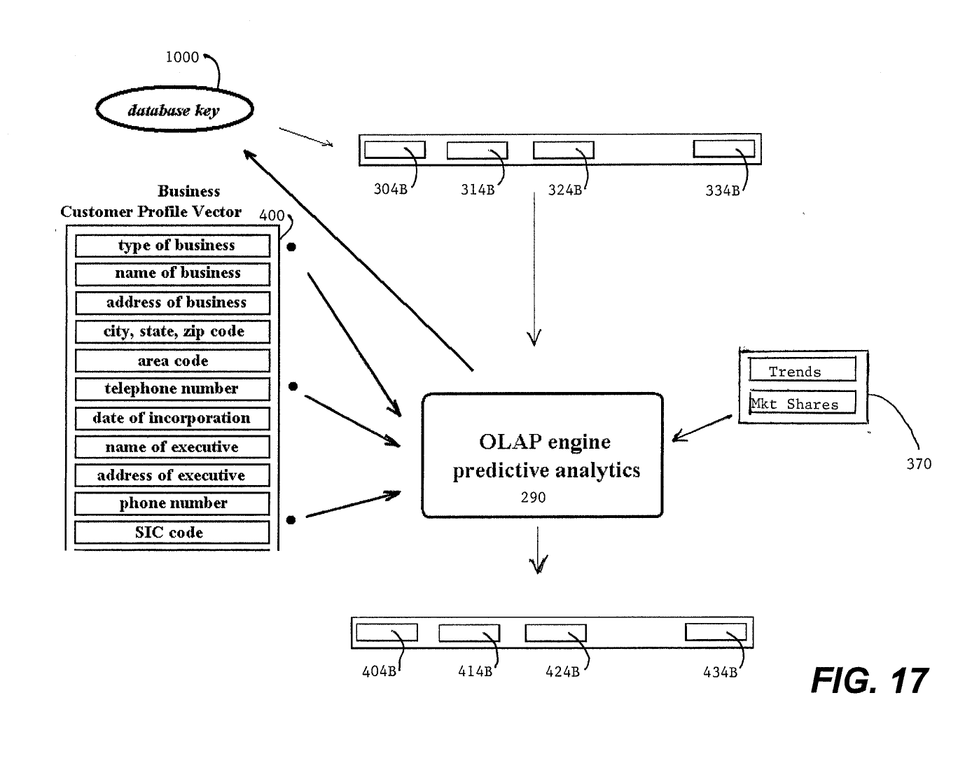

In FIG. 17, OLAP engine with predictive analytics 290 take the output vectors from FIG. 16 to a further analytical level. Purchase payments made by the business segment of retail copy centers as input vectors 304B, 314B, 324B, and 334B are processed by engine 290. Then, an additional NEDW enduser seeks to further analyze this data. The enduser is a wholesale paper distributor needing to chart its forecasted retail copy center customer demand using input vector 370. Vector 370 includes two components—a historical trend in industry paper usage, and local market shares among competing distributors. Engine 290 delivers output vectors 404B, 414B, 424B, and 434B, which are projections of the NEDW enduser's customer demand for future sales periods.

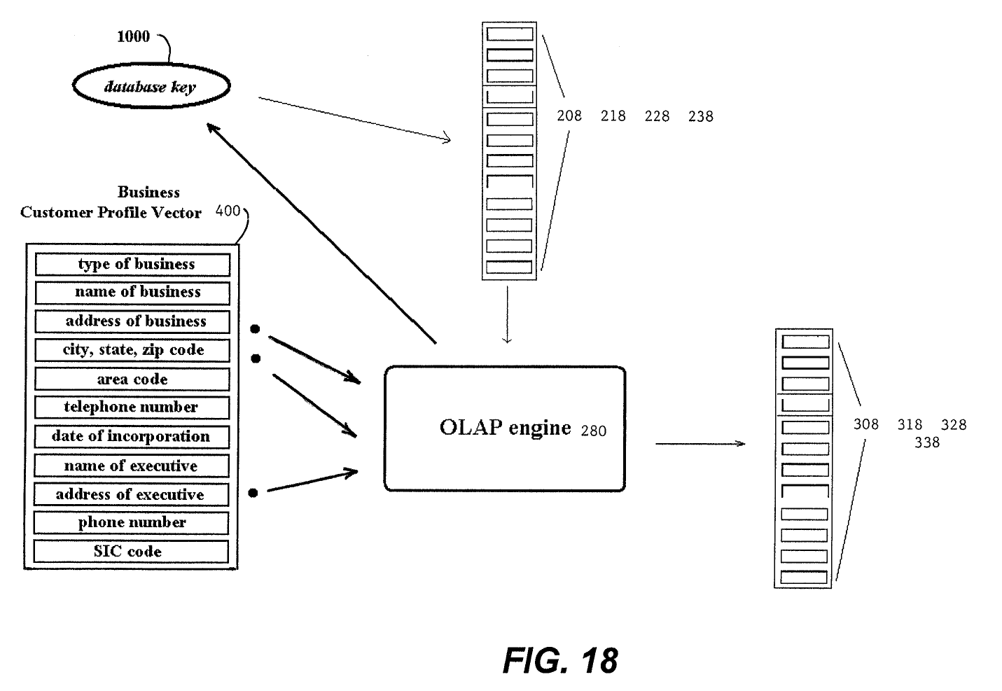

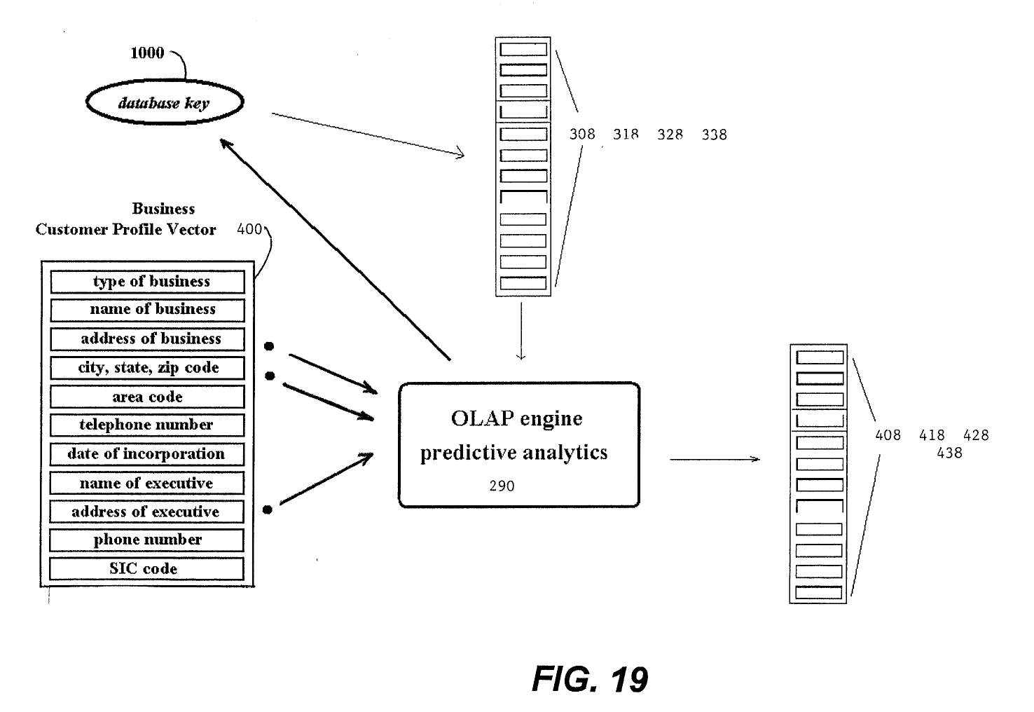

FIGS. 18 and 19 demonstrate the performance of OLAP engines with time column vectors for total business spending, regardless of category, within selected time intervals. In FIG. 18, OLAP engine accepts as input vectors 208, 218, 228, and 238, which are daily, weekly, monthly and yearly total spending shown in FIGS. 7B, 9A, 9B, and 9C. Total business spending of all businesses is narrowed to a specific metropolitan area using Business Customer Profile Vector 400 for city and zip codes for those same time periods. OLAP engine produces as the extracted business spending data output for the relevant daily, weekly, monthly, and yearly, periods as vectors 308, 318, 328, and 338.

Advanced OLAP analysis is available with OLAP engine 290 in FIG. 19. A metropolitan government agency as an NEDW enduser seeks to project business franchise tax collections for next a future year's budget. By accessing internal revenue rolls and collections contained in a relational database management system, OLAP engine 290 can make such a projection for planning and budgeting.

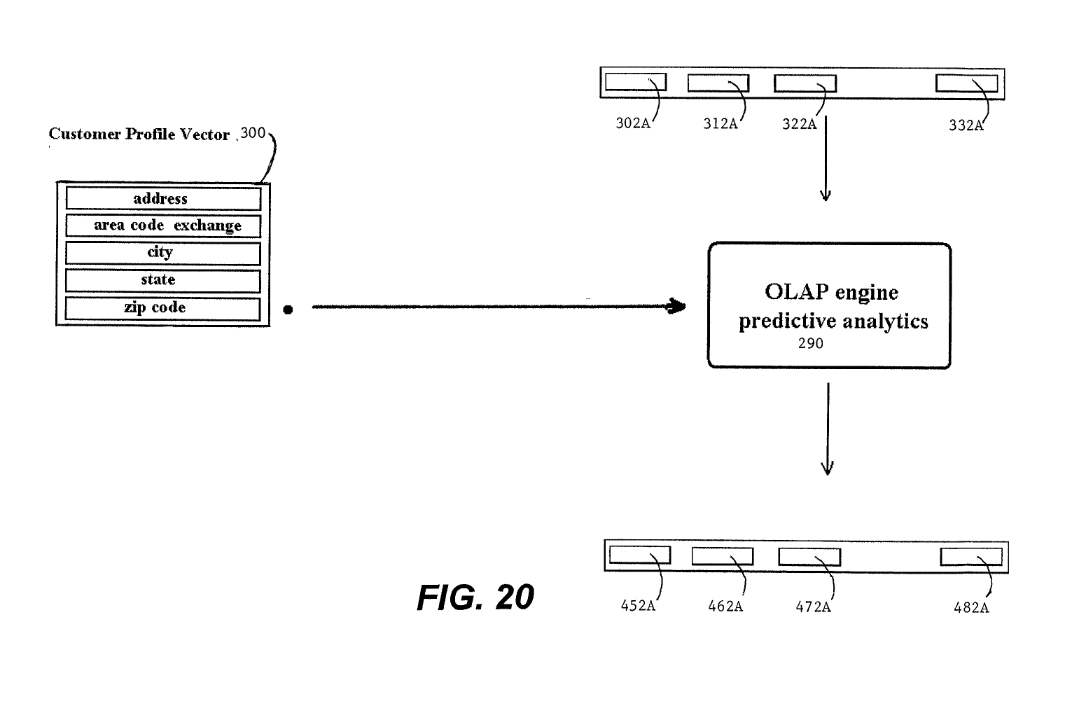

FIG. 20 presents how the invention can produce a highly advanced use of NEDW data. In FIG. 12, education spending for a given zip code for four different time periods is output vectors 302A, 312A, 322A, and 332A. These serve as the input vectors in FIG. 20. An NEDW enduser is a bank branch seeking to package and offer educational funding accounts for current and prospective customers. This requires combined analysis of four disparate data sets. Two originate from NEDW itself—education spending and investment spending in a selected zip code. The third data source becomes the local county real property records of single-family home residential tracts. The fourth is the bank branch's customer account list. OLAP engine 290 will link the four relational databases. It plots a time series analysis of investment spending against education spending. If investment spending rises faster than education, greater funds in households are available to save for college tuition of consumer households in that this geographic area. Output vectors 452A, 462A, 472A, and 482A emerge for four different time periods. This report shows projected household funds and household demand for opening educational fund accounts. The bank branch executes a marketing campaign to cross-sell its existing customers with customized mailers to targeted prospects for these financial products.

OLAP capabilities to service NEDW data are dependent on filling data cells with the total number of payment transactions. As the number of household units and businesses in the United States rise and further payment channels emerge in development and adoption, NEDW servers will expand in power, speed and number to accept and process OLAP requests, whether basic or predictive. This requires systems upgrades of additional CPUs, disk memory storage, and networking capabilities.

There are two major categories of mathematical functions for NEDW, low-order and higher-order. Low-order functions apply min/max, average, straight percentages, variances against a NEDW expenditure vector, slice, layer. These intermittent results can be feed back to OLAP engines 280 and 290 in a compare-and-contrast scenario. Because NEDW is organized logical structure of numbers, higher order analytical functions can be applied by OLAP engine 290. Accepted Newtonian mathematics opens a new vista for endusers of NEDW data, including the calculus of variations, the calculus of finite differences, integral calculus. These will create mathematical representations of the chaos theory. In fact, there is no limit as to the type of meaningful economic metrics derived from pure spending dollar data. Because time is one of the key dimensions of NEDW, in Newtonian calculus, delta t known as dt can be approximated with more granular NEDW data cells. This will greatly impact the storage requirements of NEDW.

With the right mix of parallel processors and high-speed interconnected data buses, the high-order of analytical processing can utilize Fourier analysis, algebraic polynomials, and partial differential equations to fully explore ramifications of NEDW data. Well-known computer graphics tools can visually present simple and complex data analyses. Research institutions specializing in economics forecasting are able to apply and independently develop new analytical tools based on OLAP engines that process NEDW data. Interest in this area is driven by a myriad of “what-if” scenarios involving interest rates, personal savings rates, confidence level, consumption indexes and other economic measures affecting all phases of the economy. For the public sector, the U.S. Commerce Department and Labor Department may develop and utilize NEDW analytics of consumer and spending data. The private sector can merge NEDW data and reports generated by OLAP analytics with internally culled customer information for maximum market penetration, impact and expansion. Public and private research on NEDW data will encourage collaborative efforts to share data and analytic tools for collective gain.

FIG. 21—Delivery of NEDW Data

NEDW provides usage and access with an electronic delivery system. FIG. 21 illustrates the key technology components. Internet browser 630 with the URL entered is a PC or laptop computer with Internet access. This desktop computer or notebook is connected to the Internet 628 via a telecommunications link 632. Link 632 should be a dialup 56 kbps V.90. The lower speeds at 28.8 and 14.4 kbps are likely to be too slow for NEDW OLAP queries. For power endusers, link 632 may be a dedicated DSL (digital subscriber link) or ISDN (integrated services digital network) through a RBOC (Regional Bell Operating Company) or a cable modem through a coax RG-56 or RG-59U cabling. Internet browser 630 has the facilities of an ISP. As the HTTP or SHTTP session is established, Web server 624 handles URL requests. Large-scale Web applications typically are stateless sessions. Because of the volatility in NEDW session time and depth of NEDW query as well as the vicissitudes in the volume of NEDW endusers, Web server 634 acts as a logical Internet session buffer between the Internet browser 630 and the various NEDW back-end systems servers 610, 280, 290, 612, 618, 620, 622 and 624. An NEDW enduser logs into the Internet through any over the popular browsers and get to NEDW portal screen 500. Firewall 616 is the security watchdog between public Internet 628 and REDW Intranet 600. REDW Intranet 600 has its remaining components on a Fast Ethernet or possibly a Gigabit Ethernet TCP/IP protocol stack.

The eventual logical outcome for NEDW is more Java and database servers to accommodate the data query and processing traffic from Internet 630, Network server 612 provides a high-speed data bridge, which monitors, coordinates and connects various REDWs. If there are physically or geographically dispersed NEDW OLAP cubes, then server 612 provides the telecommunications gateway to the other REDWs. There are a variety of dedicated high-speed data links available from ATM, OC-3, T1, OC-12, T3 options. These are bandwidth as well as cost-sensitive tariffs applicable to the tradeoffs between digital trunk capacity and number of resultant queries against NEDW. OLAP server 280 and OLAP server with predictive analytics 290 provide the prerequisite CPU and disk caching resources. As payments volume and associated NEDW data increase, OLAP cubes will become denser, thereby increasing the processing requirements for OLAP queries.

Hub 614 is an NEDW intranet physical device running an Ethernet backbone. Since the prevailing telecommunications cabling and wiring systems for the foreseeable future evolve around Ethernet, the logical migration path for cabling will most likely go from Fast Ethernet 10/100 BaseT category 5 to Gigabit Ethernet at 1000 mbps over copper. Optical fiber connections involving FDDI for intranets are not as numerous as those found for MANs (metropolitan area networks) and those intrinsic to the RBOCs (Regional Bell Operating Companies).

As part of a high-availability clustering solution, Java application server 620 serves to back up JAS 618. Java application server 618 seamlessly bridges public endusers and NEDW VLDB. Though not fault-tolerant, at least the important Java components are duplicated and provide some temporary systems relief during an outage of either JAS 618 or JAS 620. Clustering is not limited to just two Java Application Servers. State-of-art RISC computers support multiple RISC CPUs and theoretically hundreds of RISC computers with a high-speed interconnect bus. Symmetric multi-processing allows great strides in achieving parallelism and scalability for NEDW systems architecture.

To increase the revenue and salability of NEDW, credit card payment processor 622 charges the enduser to pay based on the type of OLAP query against NEDW and card processor 626 remits payment to owners of NEDW. Modem pool 636 consists of multiple dial-out point-to-point connections to multiple card processor 626s. Modem pool 636 facilitates scalability by processing payments of multiple NEDW endusers for OLAP queries. Due to the complexity of NEDW and requisite network and database linkages, revenue sharing among member institutions and payment processors hosting NEDW is appropriate. The basic revenue model for NEDW is the more OLAP processing for a query, the higher the charge. This is measured by the probing depth into NEDW required by dimensions and parametric qualifications.

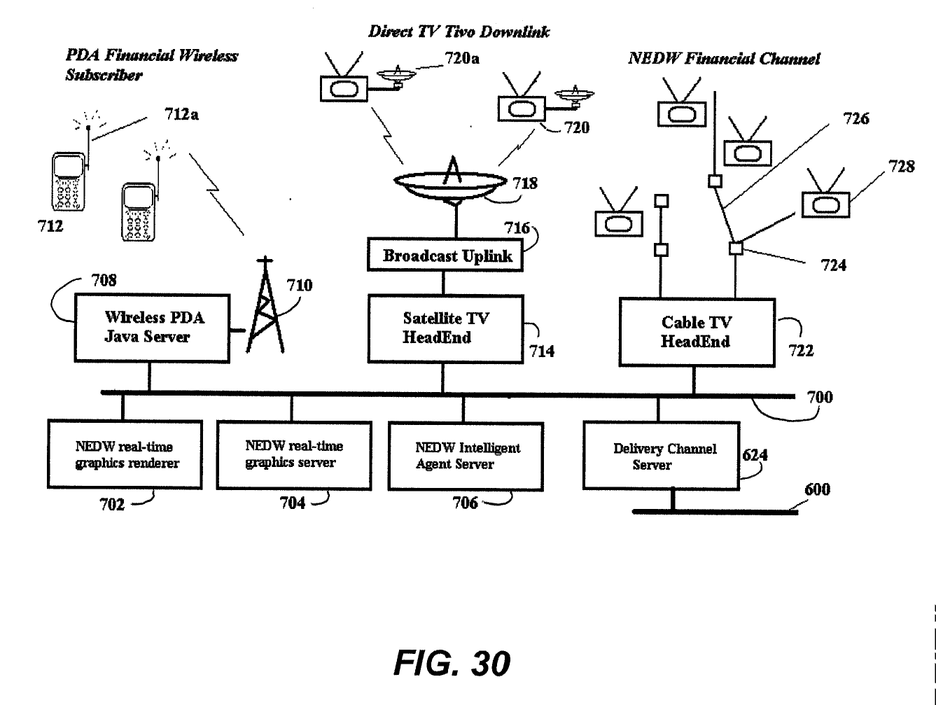

Delivery channel server 624 is discussed in the alternative embodiments. Database server 610 is the direct software interface to NEDW. OLAP server 280 examines the number of parameters and the type of SQL to be compiled and examines any cost/performance gains in processing and gauges the real-time performance of systems resources used. OLAP server 280 is CPU-bound and database server 610 supporting NEDW is I/O-bound. As the volume of Internet traffic passing through firewall 616 increases, additional database server 610s and OLAP server 280s will be installed onto REDW Intranet 600. Network server 612 is the systems component that will bridge via high-speed telecommunications private links to other databases containing expenditure data. Should queries be made across distributed NEDW data cells and warehouses, greater response time, network delays, higher data traffic congestion may warrant the collapsing of the distributed database servers into a single server for REDW Intranet 600. Completing NEDW systems infrastructure is the delivery channel server 624. The main functionality of server 624 is to direct and monitor the various expenditure row and time column vectors created by OLAP server 280 and OLAP server with predictive analytics 290 and disseminate them to the alternative subscriber channels described in FIG. 30. Delivery channel server 624 is directly connected to NEDW Delivery Channel Intranet 700, which is an Ethernet connection found in FIG. 30.

FIG. 22—NEDW/Portal

NEDW data is accessible through e-Portal sessions running on Enterprise Java Bean (EJB) systems. This EJB system supports Java's MVC (Model-View-Controller) architecture. The EJBs constitute the core of this NEDW n-tiered architecture. This systems architecture lends itself to a systematic and logical separation of functionality of the Java components and the data persistence layer found in stored procedures. As the JSP, JavaScript and cascading style sheets get propagated to NEDW computer user, session beans similar to shopping carts get activated. Unique session IDs and user-specific information similar to Netscape cookies keep track of user preferences as server-side logic as opposed to client-side logic. Java client-side logic is considered “fat-client”, that is, carrying a multitude of available features. It is difficult to control because client computers come in a myriad of systems configurations and performance characteristics.

A detailed configuration of the internals of Java application server 618 is found in FIG. 22. RISC CPU and High speed cache 668 provide the machine-level chip architecture. This can be replicated to support a shared-memory environment supporting the SMP (Symmetric MultiProcessor) configuration. Multi-threaded operating system 670 has associated look-aside and look-ahead forward fetching caching memory. The Initial Program Load is a complete reload of the current image of operating system 670 and TCP/IP protocol stack 672. Connection 666 is the physical connection between Java application server 618 and REDW Intranet 600. TCP/IP protocol stack 672 supports the three fundamental layers of the protocol—physical wire interface, data link control and addressing, and IP protocol layer.

Disk storage 660 linked by SCSI (small computer systems interface) cables to Java a application server 618 has the capacity to bring Java EJB components into EJB container 652 during an e-Portal session. Disk storage 660 acts as the physical housing for the various Java object persistence stores. EJB object persistence store 654 holds unactivated Java entity beans 674 and 682. Similarly, EJB object persistence store 656 holds unactivated Java servlets 676. EJB object persistence store 658 holds the unactivated Java Server Pages 664. Java servlets 676 act primary as gatekeepers between Java server pages 664 and Java entity beans 674 and 682. Java servlet 676 also acts as the quintessence of the Java server-side logic flow and control. Container-managed bean 682 is basically a Java wrapper around RDBMS stored procedure 662. The stored procedure is a set of precompiled SQL statements that have been optimized for a given RDBMS system inside database server 610 in FIG. 22. As connected to REDW Intranet 600 in FIG. 21, server 610 normally executes stored procedure 662 in FIG. 22. Once the result set is returned from the RDBMS, Java servlets 676 formats the n-tuple into Java Server Pages 664 for output destined to the specific e-Portal session.

As part of Java application server 618, EJB container 652 handles all the minutiae pertinent to the multiple and concurrent e-Portal sessions to NEDW. EJB container 652 provides the logical and dynamic caching for Java beans, Java servlets and Java server pages activated from EJB object persistence stores 654, 656, and 658, respectively, during an e-Portal session. Further, EJB container 652 provides a sound systems architecture for security, scalability, transaction processing, recovery, rollback, connectivity to NEDW, high availability (clustering), systems monitoring, session logging and a Java console for systems administration activities and tasks. Proper operation and systems management of EJB container 652 relies in part on EJB object persistence stores 654, 656 and 658. In the event of any system crash to RISC CPU 650, real-time Java objects active inside EJB Container 652 cease to exist but are preserved in EJB object persistence stores 654, 656 and 658. Any of the ongoing NEDW e-Portal sessions will also be expunged during the course of a systems cold-boot and IPL (Initial Program Load).

Inside EJB container 652, the Model/View/Controller is the JAVA blueprint for an n-tiered systems architecture. Model 652A inside EJB container 652 is the logical grouping of all business data Further, it controls the access of all NEDW OLAP query results in an orderly sequence and provides the critical separation between it and controller 652B. Controller 652B is the high-level blueprint for server-side Java servlets 676. The controller handles the critical business logic and proper flow control between the OLAP data and view 652C. The controller is the direct interface between the Model layer and the View layer. View 652C represents the blueprint for the necessary GUI presentation logic. All the visual information to be transmitted to the Internet browser is handled by this architectural layer. Constituents of the View layer include Java server page 664s.

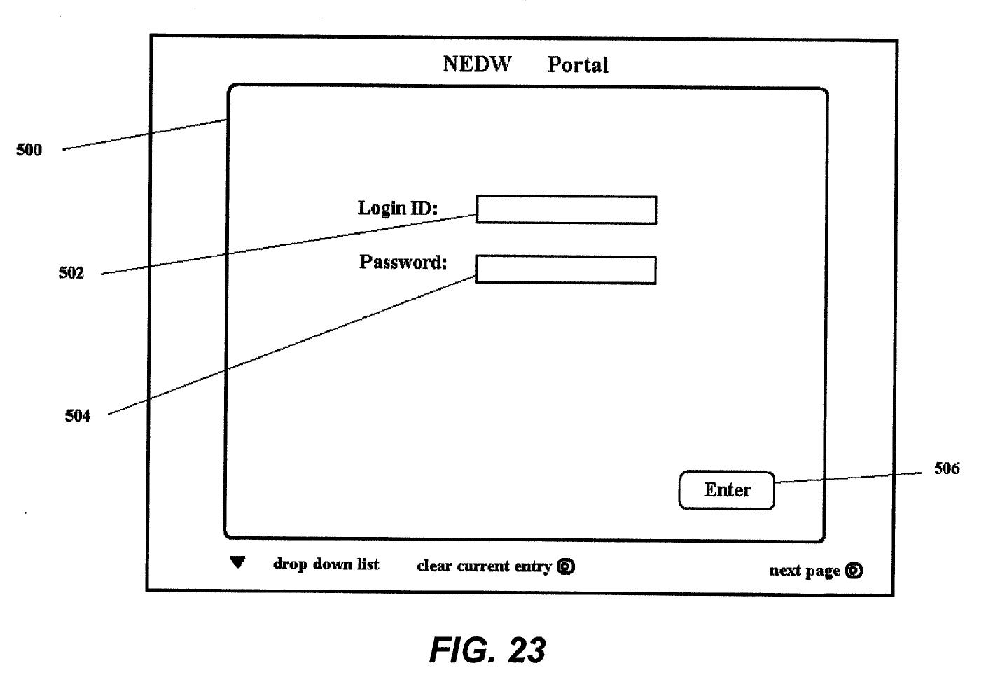

FIGS. 23 through 28—Graphical User Interface for NEDW

FIGS. 23, 24, 25, 26, 27, and 28 are Graphical User Interface (GUI) screens for NEDW endusers. All GUI screens reside within JAS 618 and 620 exclusively, as depicted in FIG. 21. These same GUI screens are individually and logically encapsulated as Java server page 664s in FIG. 22. In FIG. 21, the Internet browser 630 provides a data entry box for the URL (Uniform Resource Locator). NEDW enduser types in an Internic-approved address. Once the Internet finds the Website hosting NEDW, JAS 618 returns NEDW e-Portal 500 in FIG. 23. The screen allows only authorized endusers of NEDW by means of a validated login ID 502 and a secure, encrypted password 504. The JavaScript code will hide the actual display of the password on NEDW Portal 500 with the typical series of asterisks. The login and password are stored as part of the Java application server.

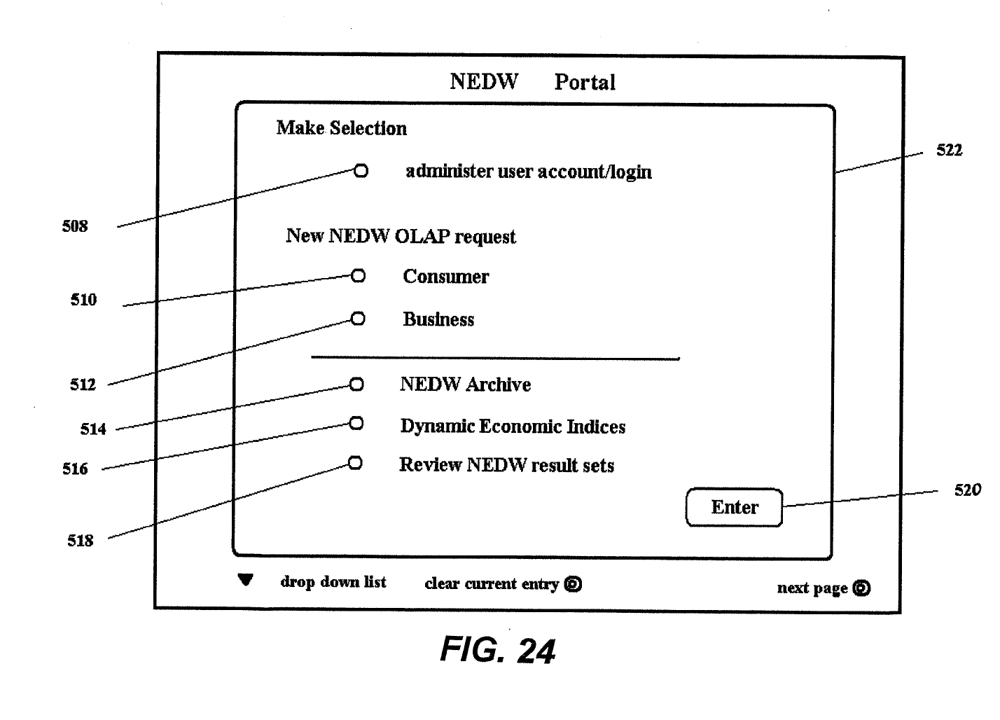

FIG. 24 shows NEDW Portal GUI screen 502. When the enduser hits enter button 506 found in FIG. 23 and upon successful validation of the user login/password sequence, GUI screen 502 in FIG. 24 appears. The enduser adjusts the user profile by clicking on the button next to the words, “administer user count/login” 508. The enduser also executes a new consumer or business OLAP request by clicking on the appropriate button 510 or 512. The enduser queries the archive 514 and the system ascertains the requested level of utilization. The enduser views expenditure indices for a given state or city on a real-time basis by selecting Dynamic Economic Indices button 516. Review NEDW result sets button 518 allows the enduser to review past NEDW queries and apply additional Boolean logic for further qualitative and quantitative analysis. The enduser has the option to compare and contrast several result sets to look for new or hidden anomalies in the economic information. When NEDW enduser is satisfied with the options selected on the GUI screen in FIG. 24, the enduser selects ENTER button 520.

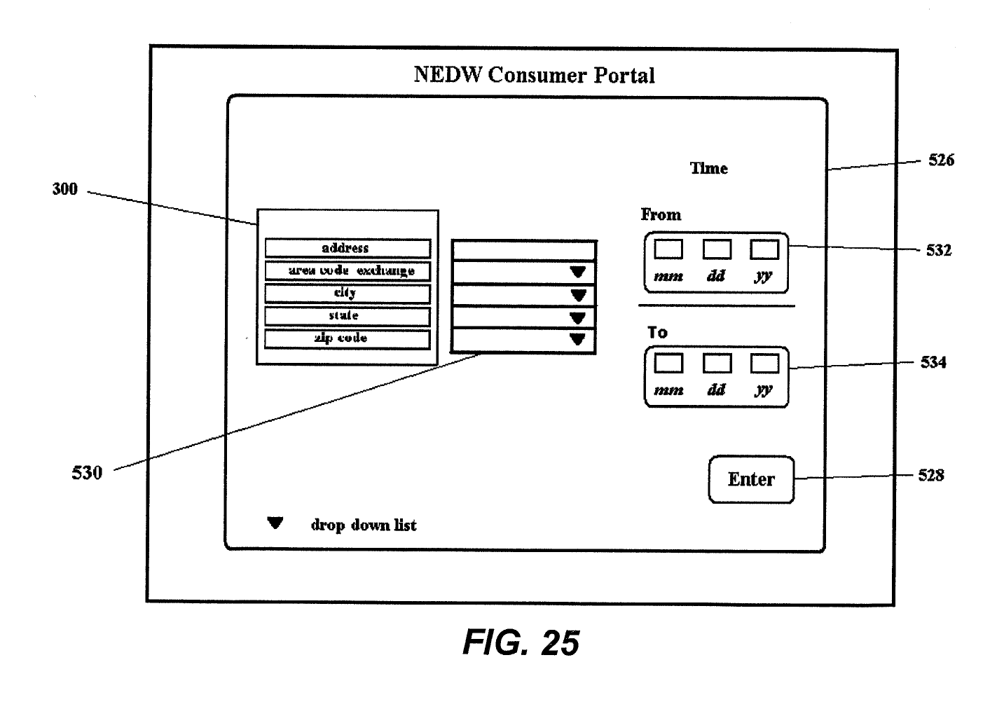

FIG. 25 is NEDW Consumer Portal GUI screen 526. On the left hand column, NEDW enduser peruses customer vector profile 300 from FIG. 12, which represents the logic space of one of the major axes of NEDW hypercube found in FIG. 1B. The enduser desires to extract NEDW data for a specific zip code and enters drop-down list 530, which is the middle column with interspersed inverted black triangles. If the enduser searches for the parameter of U.S. states, she navigates the computer mouse to the appropriate parameter state and hits the right mouse button. A drop-down list of all 50 states in alphabetical order appears, and the enduser selects the particular state. Should the enduser need to select multiple entries within the state parameter such as California, Michigan, and New Jersey, the enduser holds down the control button and depresses the right mouse button on all three states. The enduser proceeds accordingly through the various demographic parameters. For those entries that do not have an inverted black triangle associated to a drop-down list, such as street name, the enduser types from the computer keyboard the actual alphanumeric characters representing the desired parameter set.

GUI screen 526 in FIG. 25 has two time series options 532 and 534. For beginning time interval 532, the enduser puts the starting month, day and year in the corresponding boxes. Then, NEDW enduser hits the TAB key on the keyboard or clicks the mouse to move the cursor to ending time interval 534. The enduser then enters the ending date for the time series analysis. Once the enduser has entered all this data, the enduser selects the ENTER button 528.

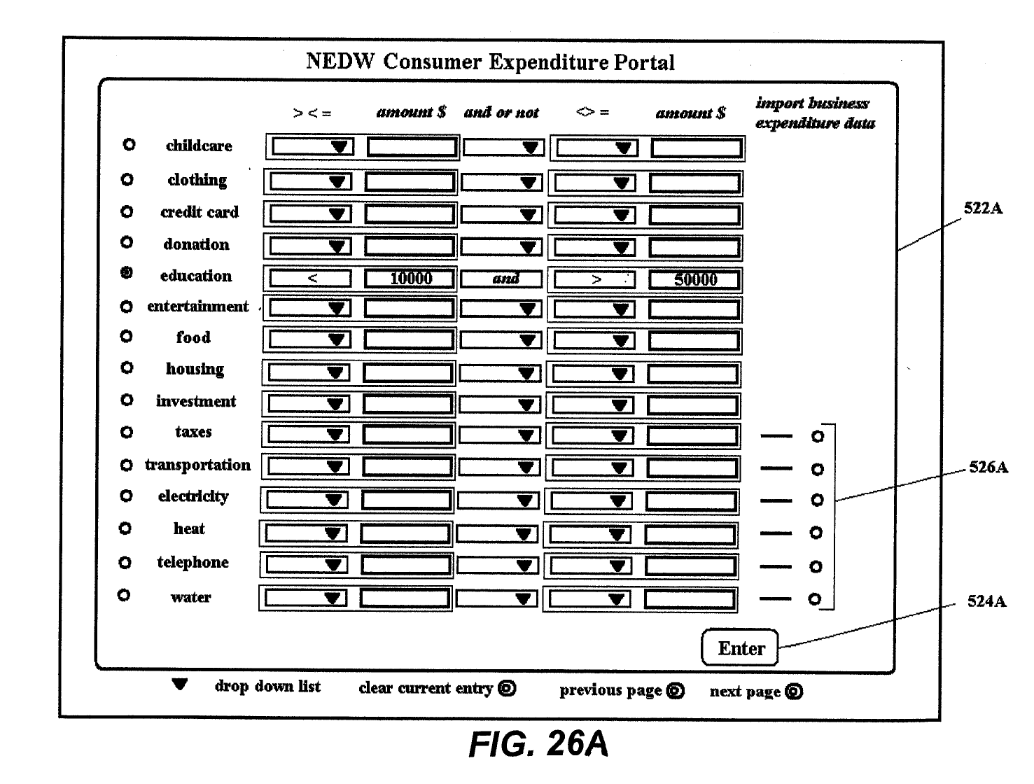

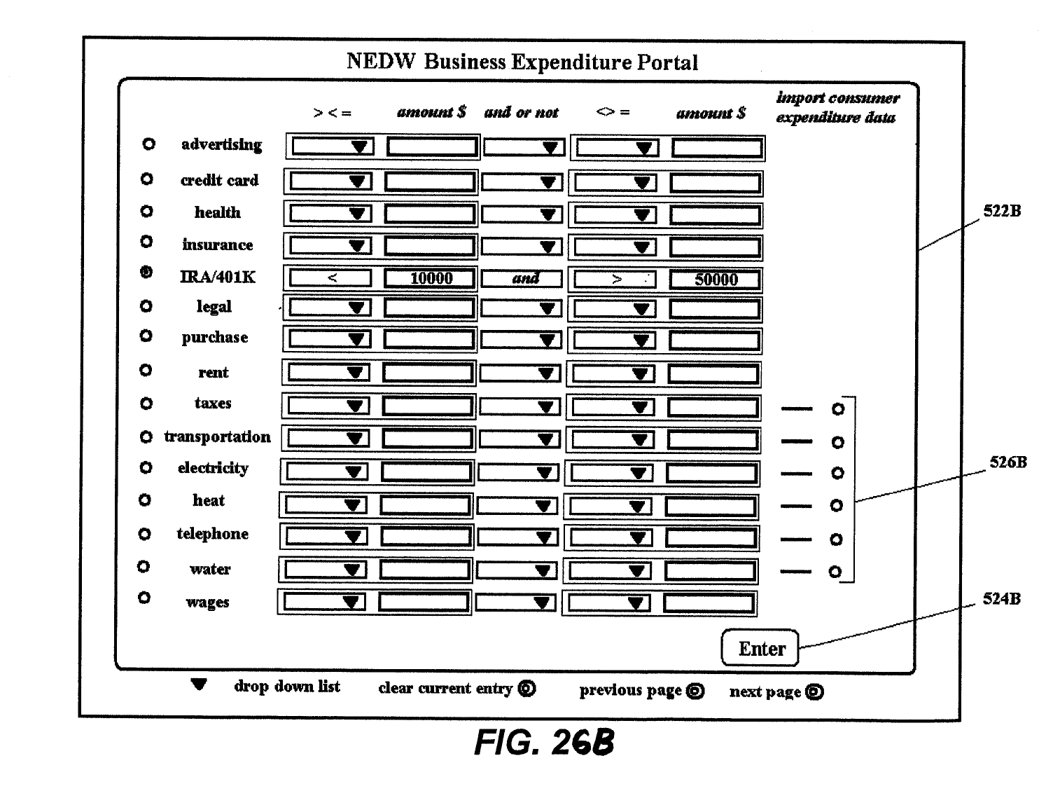

In FIG. 26A, NEDW Consumer Portal GUI screen 522A presents a layout for NEDW universal consumer expenditure categories. Here, the enduser enters a Boolean operation to search NEDW data by monetary amounts. For example, the enduser moves the mouse and selects the education button for payments of less than $10,000 and more than $50,000. The enduser may incorporate in the same OLAP query multiple NEDW consumer expenditure categories by holding the control key down and selecting the appropriate buttons located on the far left-hand side. Once the enduser has made the selection(s), the enduser hits ENTER button 524. FIG. 26B is the NEDW Business Portal GUI screen 522B which carries the similar functions as screen 522A, except for business data.

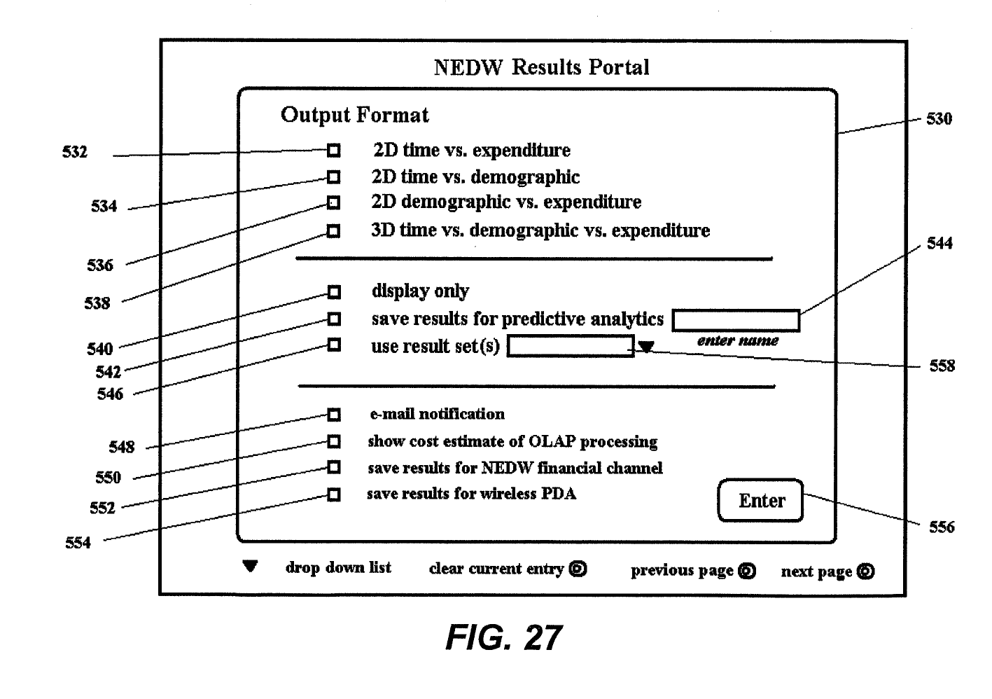

NEDW Results GUI screen 530 is shown in FIG. 27. The enduser chooses from various dimensional graphics found in Check boxes 532, 534, 536 and 538. Check box 532 provides the option to view various NEDW micro customer sheet 270s in FIG. 11C. Likewise, check box 534 offers the option to view various NEDW macro time slice 252s in FIG. 11C and check box 536 produces views of macro expenditure layer 262s in FIG. 11C. Check box 538 represents the most complex option of analyzing the full NEDW OLAP hypercube. Check box 540 provides just the results whether graphic or numeric back to Internet browser 630 in FIG. 21. Check box 542 NEDW result sets for future predictive analysis. Data entry box 544 provides an arbitrary name for the result set to be assigned by the NEDW enduser.

Check box 546 allows the option to select previous NEDW OLAP query result sets. Drop-down list 558 allows the NEDW enduser to select multiple NEDW OLAP query sets for the current NEDW query. This is an extremely practical and powerful option, since NEDW OLAP queries will be both CPU-intensive as well as I/O-bound. Check box 546 and drop-down list 558 avoid wasted time and unnecessary computer resources to rerun the same NEDW OLAP queries to achieve the same results.

Check box 548 is a time-saver option that allows the NEDW enduser to do other useful tasks other than to wait for the query to come back. This will put additional processing and accounting burdens upon the Java Application Servers 618 and 620 in FIG. 21. Check box 548 is a time-convenience option whereby the NEDW enduser will get an e-mail notification of the completion and status of the NEDW OLAP query.

To gauge the cost of the NEDW query, NEDW can calculate the number of vectors, matrices and data cells required for a custom OLAP query. By selecting check box 550, the enduser can balance the financial resources needed to formulate and calculate for the custom NEDW OLAP query against the value of information and analysis derived from the query. Check box 552 allows for the NEDW power enduser to set up NEDW results for the national and regional interest. Check box 554 allows NEDW OLAP query results to be sent to a wireless PDA for remote and the active business traveler. When the NEDW enduser is satisfied with the options selected on GUI screen 530, ENTER button 556 is hit. Thereafter, the enduser can select a variety of notification mechanisms, so that the enduser can decide whether to continue OLAP processing.

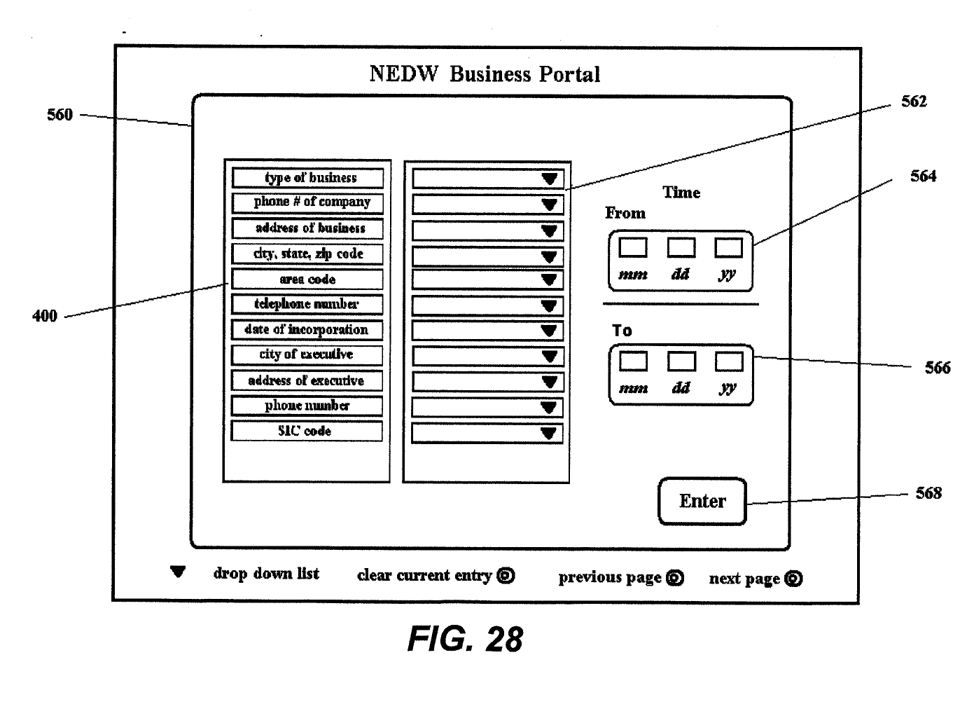

In FIG. 28, NEDW Business Portal GUI screen 560 appears. If the enduser selects on FIG. 24 under New OLAP Request button 512 for business, the enduser sees GUI screen 560 in FIG. 28. The column on the left-hand side corresponds to business customer profile vector 400 from FIG. 16, which contains demographic attributes of a business. The enduser can select a specific SIC code by depressing on the adjacent inverted black triangle. The mechanics of inputting and processing requests for specific parameters on drop-down list 562 are the same as those for consumer parameter drop-down list 530 in FIG. 25. The data entry boxes 564 and 566 are for the start and ending dates for a specific times series analysis. Following GUI screen 560, the NEDW business enduser accesses and uses GUI screens that are similar in purpose and function to the consumer portal GUI screen 522 and 530 appearing in FIGS. 26A and 27, respectively.

The consumer and business sets of categories appearing on NEDW GUI screens are standardized under NEDW to optimize the benefits for both public and private enterprises in their respective use of such expenditure data. The emergence of universal categories of the present invention aids both the individual customer and public and private endusers of NEDW data. The customer has the predictability of using a regular system, across all payment methods, of categorization for budgeting, tax preparation and retirement planning. The system is shared uniformly amongst members of the same household. Standard categories for business and government endusers of the data allow for consistency of analysis over successive periods. The present invention accommodates existing government sanctioned categories for economic analysis. This enlarges the supply of reliable consumption and spending data utilized by analytical purposes.

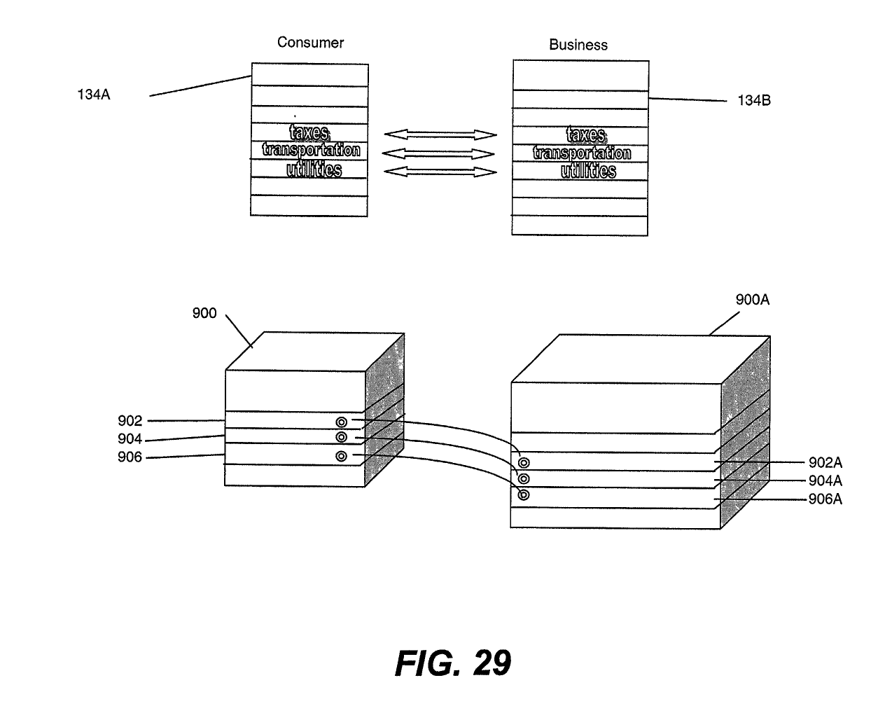

FIG. 29—Combination of NEDW Consumer and Business Payments Data

NEDW consumer and business sets of universal expenditure categories will naturally contain identical categories. FIG. 29 shows the logical and processing layout to merge common categories found in NEDW consumer cube 900 and NEDW business cube 900A. Universal consumer expenditure category set 134A and universal business expenditure category set 134B lie on the z axis of each NEDW cube. Among them, the identical categories in both cubes are include taxes, transportation, and utilities (electric, heat, telephone, and water). Macro taxes expenditure layer 902 among all consumers of cube 900 is at the same y coordinate as Macro taxes expenditure layer 902A. Likewise, macro transportation expenditure layer 904 for consumers falls on the same z coordinate as macro transportation expenditure layer 904A for businesses. Finally, macro utilities expenditure layer 906 for consumers and macro utilities expenditure layer 906A for businesses lie at the same z coordinate. As both consumer payments and business payments data are combined, they retain their NEDW dimensional coordinates. NEDW endusers can create a new set of OLAP queries against the host of OLAP engines for further macroeconomic analysis and reporting.

The NEDW portals in FIGS. 26A and 26B show how an enduser exercises this option to combine consumer and business data for OLAP analysis. The six common categories among the NEDW business cube and consumer cube have a separate column of circles on the right side of screen 522A and screen 522B in FIGS. 26A and 26B, respectively. Whether originating an OLAP request from the consumer portal or business portal, the enduser can click on circle 526A in screen 522A or 526B in screen 522B next to the desired NEDW expenditure category. This imports the NEDW data lying on the same expenditure layer in the other NEDW cube. Thus, if the enduser has formulated an OLAP query for tax payments of consumers, she may add in tax payments of businesses to enhance and expand the scope of the OLAP query.

Alternative Embodiments

Alternate embodiments include various computer systems to implement the present invention. Though there are suggested systems components utilized to realize the invention, there is flexibility in the systems architecture that does not prohibit more elegant and state-of-art methodologies.

In FIG. 5A, optical reader sorter 142 may be substituted with a hardware implementation such as an OCR facility or feature. If optical reader sorter 142, as substituted with OCR, is recalibrated, check image archive 144, check image index/database 146, check images online storage 148 and pattern recognition engine 152 are all unnecessary. This hardware alternative may not be feasible on larger reader/sorters such as the IBM 3890XP, where recalibration must use the underlying microcode known as BAL (Basic Assembly Language). This is not object-oriented and extremely difficult for even experienced software engineers. The language is working at the microprocessor chip level that is extremely vendor-specific and proprietary. Nevertheless, the OCR approach may find some application where a payment processor does not use or have access to a check image archive system and with an ancillary pattern recognition engine. Alternative check imaging vendors include Unisys, NCR and BancTec for the front-end check image MICR processing and capture.

The main embodiment has the crucial middleware software components known as Java applications servers 618 and 620 in FIG. 21. Necessarily, the critical systems architecture of NEDW is an n-tiered structure. This provides isolates the various software and hardware substructures, particularly the software component handling the dynamic Internet requests. There is a logical separation of the Java application servers 618 and 620. Other Java application servers include BEA Systems' Weblogic and Sun Microsystems, Inc.'s iplanet. An alternative to the Java technology is to utilize Microsoft's NET initiative. XML known as the Extended Markup Language is the next generation approach to have a universal and common markup language is tag-neutral. Though XML is not a Microsoft technology, what is important is that multiple end-user devices can suitably share the same common information from a back-end database. The presentation and control of graphics, text, and other data on a Web page has been and will continue to be in the near future is variations of HTML (HyperText Markup Language) originally defined by W3C, the World Wide Web consortium located in Geneva, Switzerland. XML provides an operating system and platform independent means of projecting data to wireless devices, browsers, Apple Macintoshes, Intel-based desktop computers, cell phones, PDAs. NET improves on the existing ASP (Active Server Pages) and allows for dynamically created Web pages. This technology already exists on Java Server Pages. To facilitate and augment this dynamic create, Microsoft has developed a new language called C#. Thus, the manipulation of XML via C# portends to be an industry alternative to Sun Microsystem's Java language.

Also, in FIG. 21, database server 610 has alternatives to the preferred RDBMS, such as Oracle, Sybase, SQL Server, with the right middleware to store customer and payments data. With other middleware technology such as CORBA (Common Object Request Broker Architecture), developers of NEDW can use indirectly database-stored procedures through an object request broker. The object request broker can locate the object in the object repository, so that the correct database processing module can be executed. The encapsulation of the database process or stored procedure is, in this case, a CORBA object. Thus, there is a deliberate software indirection, so that the developer of NEDW needs to know only the name of the CORBA server and the associated objects in its repository. The CORBA object has the appropriate methods and data to execute the database query. Companies such as Iona Technologies and Borland Inprise have CORBA servers to implement an n-tiered architecture. The key industry proponent of the CORBA specification is the Object Management Group. OLAP servers 280 and 290 in FIG. 21 have alternatives as well. There are many established software firms that have OLAP algorithms and sophisticated search/query engines to data mine a data warehouse. NEDW is a hypercube where there are many dimensions to the VLDB (very large database). The OLAP algorithms provide efficient means to extract the meaningful economic data while conserving on computer processing time.

FIG. 30 depicts other means of distributing reliable NEDW data. NEDW Channel Intranet 700 represents the Ethernet backbone of all NEDW information delivery devices for the public to take advantage of. In the main embodiment, FIGS. 2 and 21 illustrate the Internet as the principal means of disseminating and accessing NEDW data. Internet browser 630 as a commodity make universal access to NEDW commonplace. There are three other major public delivery channels besides the Internet. These subscriber channels are typically not interactive because they are individual data and information links. First is the wireless PDA Java server 708. IBM's Websphere with the Transcoder plug-in, provide the necessary logic to communicate from wireless PDA Java Server 708 to the actual wireless PDA 712. With the needed logic to derive and calculate NEDW economic data, the enduser with the wireless PDA 712 can access any NEDW data in a cryptic format. The advantages of such an alternative include addressing a vast new population of NEDW subscribers who are actively mobile. Companies such as Palm, Bluetooth, and Handspring offer small, handheld devices with low power consumption and great portability. Dynamic, affordable delivery of valued NEDW data avoids potential inequities among various business sectors and socioeconomic segments. The high frequency antenna 710 propagates NEDW data to the wireless PDA 712. PDA processes pen computing commands and transmits them from the wireless antenna 712a back to antenna 710.

Another portion of the electromagnetic spectrum at the gigahertz level is for consumer one-meter low noise satellite receivers. The number of subscribers has not reached the levels of cable television penetration. However, with the appropriate efforts to propagate and amplify the signal, millions of the popular Direct TV Tivo service could access a financial news channel featuring various economic indices garnered from the OLAP server extracting data packets and slivers from NEDW. To provide even greater penetration to the general public who are not Internet-connected, a NEDW financial channel could be set up on a cable television network, 24 hours a day, seven days a week. The satellite TV Headend 714 provides the overall signal propagation to the discrete analog components broadcast uplink 716 and uplink 718. A Direct TV subscriber uses TV 720 to view NEDW data and small 18″ downlink satellite dish 720a to receive the analog signal propagated from uplink antenna 718.

In FIG. 30, NEDW Intelligent Agent Server 706 can trigger monthly, weekly, and daily alerts so that the other servers are listening on the local area network highlighted as a dark black horizontal line. The particular NEDW server will listen to whether that event is for the server to execute some productive work such as producing a bar chart, processing XML data for a wireless PDA device, or producing a moving 3-D graph depicting clothing expenditure dynamics within a selected MSA or zip code. To off-load the computer graphics rendering and handling of the real-time 2D and 3D graphics representation, NEDW real-time graphics renderer server 702 and NEDW real-time graphics server 704 provides the essential functionality.

NEDW Financial Channel is depicted by Cable TV Headend 722. The CATV (community antenna television) amplifiers, attenuators and splitters are electronic constituents of CATV housing 724. Coax trunk 726 is typically RG-11 pest-proof, weatherproof underground cabling. TV 728 is a typical cable TV subscriber. Delivery channel server 624 is the logical and physical gateway to Java application servers 618 and 620 found in FIG. 21.

There is no limitation as to the type of local area network that needs to support the alternate subscriber/delivery channels. The local area network can be a Fast Ethernet, Gigabit Ethernet, 155 Mb ATM (Asynchronous Transfer Mode). As long as all the servers graphically depicted in FIG. 30 can physically attach themselves with the right hardware and software protocol stack, NEDW has great flexibility in cost and in delivery options to public and private sector endusers.

What is claimed is:

1. A computer-based system, comprising:
pre-processor means for performing payment processing between a plurality of consumer payers and a plurality of payees;
database means connected to said pre-processor means for storing a plurality of payment transaction records having data fields for each of such plurality of payment transaction records including at least date and time of processing, amount in local currency, identity of a payer, and identity of a payee;
post-processor means comprising:
a) means for receiving from said database means connected to said pre-processor means an additional data field that indicates a spending classification code associated with each of said plurality of payment transaction records;
b) means for discerning a status of said additional data field from a group of statuses consisting of coded status, miscoded status, and empty status;
c) means for assigning, to each of said plurality of payment transaction records where its said additional data field has a coded status, a single expenditure category code selected from a unique, predetermined set of universal expenditure categories each identified by at least one key word;
d) means for assigning, to each of said plurality of payment transaction records where its said additional data field has a miscoded status, a single expenditure category code selected from said unique, predetermined set of universal expenditure categories, which said means for assigning is based on content residing in other data fields associated with each of said payment transaction records;
e) heuristic means for assigning, to each of said plurality of payment transaction records where its said additional data field has an empty status, a single expenditure category code selected from said unique, predetermined set of universal expenditure categories, which said means for assigning is based on content residing in other data fields associated with each of said payment transaction records;
memory means connected to said post-processor for storing universal expenditure categorized payment transaction records, each comprising of data fields originating from pre-processor means and a separate data field for said single expenditure category code as assigned by said post-processor means;
database means for storing with said memory means said storing universal expenditure categorized payment transaction records;
output means connected to said post-processor and said database means for transmitting said storing universal expenditure categorized payment transaction records; and network means for connecting said pre-processor means, said post-processor means, said memory means, said database means, and said output means.

2. A computer-based system according to claim 1 wherein a plurality of said post-processor means are operated at different locations comprising:
network means for connecting said plurality of post-processors according to network topologies selected from a group consisting of ring, tree, cluster, mesh, and a hybrid of a plurality of a group consisting of ring, tree, cluster and mesh; and
cryptography means for providing security of data transmission among said plurality of post-processor means.

3. A method for analyzing pre-processed payment transaction records of consumer payers in a data mart system generated by at least one post-processor and one analytical application executing on at least one client computer, the data mart system being composed of a plurality of storage media devices and a plurality of data network computers, the method comprising the steps of:
a) accepting from a plurality of pre-existing databases of said pre-processed payment transaction records of consumer payers, each of said records containing at least of processing date and time of payment, amount of payment in local currency, residence address of consumer payer consisting of zip code only, identity of payee, and a pre-processor spending classification for consumer financial management if recorded in said pre-existing databases, which step creates post-processed payment transaction records of consumer payers;
b) marking each of said post-processed payment transaction records of consumer payers with a unique transaction number within said data mart system;
c) converting said pre-processor spending classification in each of said post-processed payment transaction records of consumer payers into at least one word according to a predefined table; and
d) applying at least one of a predetermined set of criteria to assign to each of said post-processed payment transaction records of consumer payers a category selected from a unique, predetermined set of universal consumer expenditure categories each identified by at least one key word.

4. The method according to claim 3 wherein said post-processor assigns one of said universal consumer expenditure categories to each of said post-processed payment transaction records of consumer payers by executing a series of steps consisting of (i) matching a root word of said pre-processor spending classification to a root word of a key word identifying one of said universal consumer expenditure categories, (ii) linking said pre-processor spending classification to one of said universal consumer expenditure categories using a synonym database, (iii) grouping said pre-processor spending classification under one of said universal consumer expenditure categories according to a predetermined subcategory database, and (iv) where said pre-processor spending classification does not exist for said post-processed payment transaction record, assigning one of said universal consumer expenditure categories using said identity of payee contained in said post-processed payment transaction record.

5. The method according to claim 3 wherein said post-processed payment transaction records of consumer payers are aggregated into aggregated post-processed consumer payment transaction records by geographic locations of consumer residence addresses; wherein said geographic locations of consumer resident addresses comprise a plurality of geographic region designations; wherein said geographic region designations are selected from a group consisting of nine-digit zip codes, a plurality of nine-digit zip codes, five-digit zip codes, a plurality of five-digit zip codes, zip codes truncated up to a maximum extent leaving at least the first leading digit remaining, a plurality of such truncated zip codes, subdivision, a plurality of subdivisions, township, a plurality of townships, city, a plurality of cities, metropolitan statistical area, a plurality of metropolitan statistical areas, consolidated metropolitan statistical area, a plurality of consolidated metropolitan statistical areas, county, a plurality of counties, building code zone, a plurality of building code zones, state, a plurality of states, time zone, a plurality of time zones, topographical region, a plurality of topological regions, meteorological add region, a plurality of meteorological regions, country, a plurality of countries, continent, and a plurality of continents.

6. The method according to claim 3 wherein said post-processed payment transaction records of consumer payers are aggregated into aggregated post-processed consumer payment transaction records by residence telephone numbers of said consumer payers consisting of a plurality of area codes and a plurality of telephone exchange code areas identified by area codes and three-digit exchange codes associated with each of said area codes.

7. The method according to claim 3 wherein said payment transaction records of consumer payers are aggregated into aggregated post-processed consumer payment transaction records by processing date and time of payment into a plurality of time intervals; wherein said time intervals are selected from a group consisting of a plurality of minutes, an hour, a plurality of hours less than 24 within a single calendar day, a calendar day, a plurality of hours up to 24 spanning across two calendar days, a plurality of days up to a calendar week, a plurality of calendar days of multiple calendar weeks, a calendar week, a plurality of days, a plurality of weeks, a month, a plurality of months, a calendar quarter, a calendar year, a fiscal year, a plurality of calendar years, a plurality of fiscal years, and a decade.

8. The method according to claim 5 wherein said analytical application performs a plurality of functions with amounts of payment for said aggregated post-processed consumer payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed consumer payment transaction records to perform estimates and projections for the entire population of consumers within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

9. The methods according to claim 6 wherein said analytical application performs a plurality of functions with amounts of payment for said aggregated post-processed consumer payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed consumer payment transaction records to perform estimates and projections for the entire population of consumers within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

10. The method according to claim 7 wherein said analytical application performs a plurality of functions with amounts of payment for said aggregated post-processed consumer payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed consumer payment transaction records to perform estimates and projections for the entire population of consumers within a plurality of said geographic region designations;
e) creating economic models based upon a plurality of tools, including the calculus of variations, the calculus of finite differences, integral calculus, the family of ordinary and partial differential equations, related transforms, matrix algebras, higher-order polynomials, chaos theory, the theory of complex numbers, and fractal analysis.

11. A method for analyzing pre-processed payment transaction records of business payers in a data mart system generated by at least one post-processor and one analytical application executing on at least one client computer, the data mart system being composed of a plurality of storage media devices and a plurality of data network computers, the method comprising the steps of:
a) accepting from a plurality of pre-existing databases of said pre-processed payment transaction records of business payers, each of said records containing at least of processing date and time of payment, amount of payment in local currency, address of business payer including street address and zip code, identity of business payer, identity of payee, and a pre-processor spending classification for business financial management if recorded in said pre-existing databases, which step creates post-processed payment transaction records of business payers;
b) marking each of said post-processed payment transaction records of business payers with a unique transaction number within said data mart system;
c) converting said pre-processor spending classification in each of said post-processed payment transaction records of business payers into at least one word according to a predefined table; and
d) applying at least one of a predetermined set of criteria to assign to each of said post-processed payment transaction records of business payers a category selected from a unique, predetermined set of universal business expenditure categories each identified by at least one key word.

12. The method according to claim 11 wherein said post-processor assigns one of said universal business expenditure categories to each of said post-processed payment transaction records of business payers by executing a series of steps in preferential order of (i) matching a root word of said pre-processor spending classification to a root word of a key word identifying one of said universal business expenditure categories, (ii) linking said pre-processor spending classification to one of said universal business expenditure categories using a synonym database, (iii) grouping said pre-processor spending classification under one of said universal business expenditure categories according to a predetermined subcategory database, and (iv) where said pre-processor spending classification does not exist for said post-processed payment transaction record, assigning one of said universal business expenditure categories using said identity of payee contained in said post-processed payment transaction record.

13. The method according to claim 11 wherein said post-processed payment transaction records of business payers are aggregated into aggregated post-processed business payment transaction records by geographic locations of business office address; wherein said geographic locations comprise of a plurality of geographic region designations; wherein said geographic region designations are selected from a group consisting of census block, a plurality of census blocks, census tract, a plurality of census tracts, nine-digit zip codes, a plurality of nine-digit zip codes, five-digit zip codes, a plurality of five-digit zip codes, zip codes truncated up to a maximum extent leaving at least the first leading digit remaining, a plurality of such truncated zip codes, subdivision, a plurality of subdivisions, township, a plurality of townships, city, a plurality of cities, metropolitan statistical area, a plurality of metropolitan statistical areas, consolidated metropolitan statistical area, a plurality of consolidated metropolitan statistical areas, county, a plurality of counties, building code zone, a plurality of building code zones, state, a plurality of states, time zone, a plurality of time zones, topographical region, a plurality of topological regions, meteorological region, a plurality of meteorological regions, country, a plurality of countries, continent, and a plurality of continents.

14. The method according to claim 11 wherein said post-processed transaction records of business payers are aggregated into aggregated post-processed business transaction records by telephone numbers of said business payers consisting of a plurality of area codes and a plurality of telephone exchange code areas identified by area codes and three-digit exchange codes associated with each of said area codes.

15. The method according to claim 11 wherein said post-processed payment transaction records of business payers are aggregated into aggregated post-processed business payment transaction records by processing date and time of payment into a plurality of time intervals; wherein said time intervals are selected from a group consisting of a plurality of minutes, an hour, a plurality of hours less than 24 within a single calendar day, a calendar day, a plurality of hours up to 24 spanning across two calendar days, a plurality of days up to a calendar week, a plurality of calendar days of multiple calendar weeks, a calendar week, a plurality of days, a plurality of weeks, a month, a plurality of months, a calendar quarter, a calendar year, a plurality of calendar years, a fiscal year, a plurality of fiscal years, and a decade.

16. The method according to claim 13 wherein said analytical application performs a plurality of functions with amounts of payment for said aggregated post-processed business payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed business payment transaction records to perform estimates and projections for the entire population of businesses within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

17. The method according to claim 14 wherein said analytical application performs a plurality of functions with amounts of payment for said aggregated post-processed business payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed business payment transaction records to perform estimates and projections for the entire population of business within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

18. The method according to claim 15 wherein said analytical application performs a plurality of functions with amounts of payment for aggregated post-processed business payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed business payment transaction records to perform estimates and projections for the entire population of businesses within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

19. A method for analyzing pre-processed payment transaction records of consumer payers and business payers in a data mart system generated by at least one post-processor and one analytical application executing on at least one client computer, the data mart system being composed of a plurality of storage media devices and a plurality of data network computers, the method comprising the steps of:
a) accepting from a plurality of pre-existing databases of said pre-processed payment transaction records of consumer payers and business payers, each of said records containing at least of processing date and time of payment, amount of payment in local currency, address of payer consisting of zip code only, identity of payee, and a pre-processor spending classification for payer financial management if recorded in said pre-existing databases, which step which step creates post-processed payment transaction records of payers;
b) marking each of said post-processed payment transaction records with a unique transaction number within said data mart system;
c) converting said pre-processor spending classification in each of said post-processed payment transaction records into at least one word according to a predefined table; and
d) applying at least one of a predetermined set of criteria to assign to each of said post-processed payment transaction records a category selected from unique, predetermined sets of universal expenditure categories each identified by at least one key word.

20. The method according to claim 19 wherein said post-processor assigns one of said universal expenditure categories to each of said post-processed payment transaction records by executing a series of steps in preferential order of (i) matching a root word of said pre-processor spending classification to a root word of a key word identifying one of said universal expenditure categories, (ii) linking said pre-processor spending classification to one of said universal expenditure categories using a synonym database, (iii) grouping said pre-processor spending classification under one of said universal expenditure categories according to a predetermined subcategory database, and (iv) where said pre-processor spending classification does not exist for said post-processed payment transaction record, assigning one of said universal expenditure categories using said identity of payee contained in said business payment transaction record.

21. The method according to claim 19 wherein said post-processed payment transaction records of payers are aggregated into aggregated post-processed payment transaction records by geographic locations of addresses of said payers; wherein said geographic locations comprise of a plurality of geographic region designations; wherein said geographic region designations are selected from a group consisting of nine-digit zip codes, a plurality of nine-digit zip codes, five-digit zip codes, a plurality of five-digit zip codes, zip codes truncated up to a maximum extent leaving at least the first leading digit remaining, a plurality of such truncated zip codes, subdivision, a plurality of subdivisions, township, a plurality of townships, city, a plurality of cities, metropolitan statistical area, a plurality of metropolitan statistical areas, consolidated metropolitan statistical area, a plurality of consolidated metropolitan statistical areas, county, a plurality of counties, building code zone, a plurality of building code zones, state, a plurality of states, time zone, a plurality of time zones, topographical region, a plurality of topological regions, meteorological region, a plurality of meteorological regions, country, a plurality of countries, continent, and a plurality of continents.

22. The method according to claim 19 wherein said post-processed transaction records of payers are aggregated into aggregated post-processed payment transaction records by principal telephone numbers of payers, wherein said principal telephone numbers consist of a plurality of area codes and a plurality of telephone exchange code areas identified by area code and corresponding three-digit exchange codes.

23. The method according to claim 19 wherein said post-processed payment transaction records of payers are aggregated into aggregated post-processed payment transaction records by processing date and time of payment into a plurality of time intervals; wherein said time intervals are selected from a group consisting of a plurality of minutes, an hour, a plurality of hours less than 24 within a single calendar day, a calendar day, a plurality of hours up to 24 spanning across two calendar days, a plurality of days up to a calendar week, a plurality of calendar days of multiple calendar weeks, a calendar week, a plurality of days, a plurality of weeks, a month, a plurality of months, a calendar quarter, a calendar year, a plurality of calendar years, a fiscal year, a plurality of fiscal years, and a decade.

24. The method according to claim 21 wherein said analytical application performs a plurality of functions with amounts of payment for said aggregated post-processed payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed payment transaction records to perform estimates and projections for the entire population of payers within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

25. The method according to claim 22 wherein said analytical application performs a plurality of functions with amounts of payment for said aggregated post-processed payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed payment transaction records to perform estimates and projections for the entire population of payers within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.

26. The method according to claim 23 wherein said analytical application performs a plurality of functions with amounts of payment for said aggregated post-processed payment transaction records, the method consisting of:
a) performing a summation of said amounts of payments;
b) creating statistical and mathematical comparisons of said summations between and among a plurality of said geographic region designations;
c) creating statistical and arithmetic comparisons of said summations between and among a plurality of said time intervals;
d) sampling randomly from said aggregated post-processed payment transaction records to perform estimates and projections for the entire population of payers within a plurality of said geographic region designations;
e) creating economic models based upon a plurality of calculus tools, including the calculus of variations, the calculus of finite differences, integral calculus, the family of ordinary and partial differential equations, related transforms, matrix algebras, higher-order polynomials, chaos theory, the theory of complex numbers, and fractal analysis.
